(19) United States
(12) Patent Application Publication
(10) Pub. No.: US 2026/0208490 A1
(43) Pub. Date: Jul. 23, 2026

(54) MOISTURIZING UNIT AND LIQUID EJECTION APPARATUS

(71) Applicant: SEIKO EPSON CORPORATION, Tokyo (JP)

(72) Inventor: Hiromichi TAKANASHI, SHIOJIRI-SHI (JP)

(21) Appl. No.: 19/448,219

(22) Filed: Jan. 14, 2026

(30) Foreign Application Priority Data
Jan. 17, 2025 (JP) 2025-006672

(51) Int. Cl. B41J 2/165

(52) U.S. Cl. CPC B41J 2/16579; B41J 2/16505; B41J 2002/16594

(57) ABSTRACT

A moisturizing unit includes a reservoir section storing a moisturizing liquid, and an adjustment section adjusting a concentration of the moisturizing liquid stored in the reservoir section, the adjustment section includes a liquid level sensor that detects that a liquid level of the moisturizing liquid stored in the reservoir section is a reference liquid level, and a supply mechanism that supplies a replenishment liquid for replenishing moisture to the moisturizing liquid to the reservoir section, and the supply mechanism supplies the replenishment liquid to the reservoir section to maintain the moisturizing liquid in a first liquid amount by maintaining the moisturizing liquid at the reference liquid level when the moisturizing liquid moisturizes a first ejection liquid, and supplies the replenishment liquid to the reservoir section to maintain the moisturizing liquid in a second liquid amount larger than the first liquid amount when the moisturizing liquid moisturizes a second ejection liquid.

The present application is based on, and claims priority from JP Application Serial Number 2025-006672, filed January 17, 2025, the disclosure of which is hereby incorporated by reference herein in its entirety.

### BACKGROUND

### Technical Field

The present disclosure relates to a moisturizing unit and a liquid ejection apparatus.

### Related Art

JP-A-2022-30421 describes a liquid ejection apparatus including an ejection unit that ejects an ejection liquid and a moisturizing unit that moisturizes the ejection liquid. The moisturizing unit is configured to moisturize the ejection liquid with a moisturizing liquid. The moisturizing unit maintains the concentration of the moisturizing liquid by supplying a replenishment liquid for replenishing moisture to the moisturizing liquid according to evaporation of the moisturizing liquid.

JP-A-2022-30421 is an example of the related art.

In the moisturizing unit described in JP-A-2022-30421, when the ejection unit uses a first ejection liquid, it is necessary to fill the moisturizing unit with a moisturizing liquid having a concentration suitable for moisturizing the first ejection liquid. In the moisturizing unit, when the ejection unit uses a second ejection liquid different from the first ejection liquid, it is necessary to fill with the moisturizing liquid having a concentration suitable for moisturizing the second ejection liquid. As described above, in the moisturizing unit, it is difficult to cope with moisturizing of the first ejection liquid and moisturizing of the second ejection liquid with a single moisturizing liquid.

### SUMMARY

A moisturizing unit according to an aspect of the present disclosure is a moisturizing unit that moisturizes a first ejection liquid or a second ejection liquid supplied to an ejection unit, including a reservoir section that stores a moisturizing liquid, and an adjustment section that adjusts a concentration of the moisturizing liquid stored in the reservoir section, wherein the adjustment section includes a liquid level sensor that detects that a liquid level of the moisturizing liquid stored in the reservoir section is a reference liquid level, and a supply mechanism that supplies a replenishment liquid for replenishing moisture to the moisturizing liquid to the reservoir section, and the supply mechanism supplies the replenishment liquid to the reservoir section to maintain the moisturizing liquid in a first liquid amount by maintaining the moisturizing liquid at the reference liquid level when the moisturizing liquid moisturizes the first ejection liquid, and supplies the replenishment liquid to the reservoir section to maintain the moisturizing liquid in a second liquid amount larger than the first liquid amount when the moisturizing liquid moisturizes the second ejection liquid.

A liquid ejection apparatus according to another aspect of the present disclosure includes the moisturizing unit and the ejection unit.

### BRIEF DESCRIPTION OF THE DRAWINGS

FIG. 1 shows a liquid ejection apparatus including a moisturizing unit.

FIG. 2 shows a reservoir section filled with a moisturizing liquid.

FIG. 3 shows a first embodiment of the moisturizing unit.

FIG. 4 shows a second embodiment of the moisturizing unit.

FIG. 5 shows a third embodiment of the moisturizing unit.

FIG. 6 shows a fourth embodiment of the moisturizing unit.

FIG. 7 shows a fifth embodiment of the moisturizing unit in a filled state.

FIG. 8 shows the fifth embodiment of the moisturizing unit in a used state.

FIG. 9 shows a sixth embodiment of the moisturizing unit in a filled state.

FIG. 10 shows the sixth embodiment of the moisturizing unit in a used state.

### DESCRIPTION OF EMBODIMENTS

Hereinafter, one embodiment of a liquid ejection apparatus will be described with reference to the drawings. The liquid ejection apparatus is an inkjet printer that records an image such as a character or a photograph by ejecting ink, which is an example of an ejection liquid, onto a medium such as paper, fabric, or a film.

### Common Configuration

In the present specification, a plurality of embodiments of a liquid ejection apparatus including a moisturizing unit will be described. Therefore, first, a configuration common to the plurality of embodiments will be described.

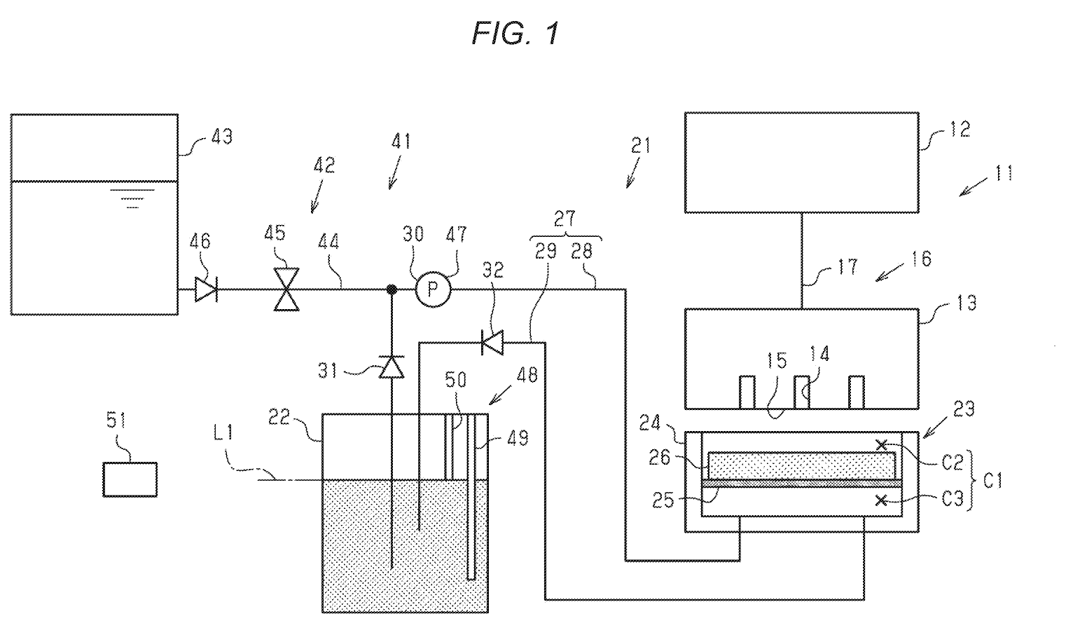

As illustrated in FIG. 1, a liquid ejection apparatus 11 is configured such that the ejection liquid is supplied from a liquid container 12. The ejection liquid is a liquid used by the liquid ejection apparatus 11 for printing. The liquid container 12 is, for example, an ink cartridge. In this case, the liquid ejection apparatus 11 is configured so that the liquid container 12 is attached thereto. The liquid container 12 may be an ink tank. In this case, the liquid ejection apparatus 11 may include the liquid container 12.

The liquid container 12 is configured to contain the ejection liquid. Specifically, the liquid container 12 is configured to contain a first ejection liquid or a second ejection liquid. The first ejection liquid and the second ejection liquid are liquids of different types. The first ejection liquid and the second ejection liquid are, for example, inks of different colors. The first ejection liquid and the second ejection liquid contain a printing material and a solvent. The printing material may be a pigment or a dye. The solvent is, for example, water.

Whether the liquid ejection apparatus 11 is of a model using the first ejection liquid or a model using the second ejection liquid may be determined at the time of shipment. In the liquid ejection apparatus 11, whether to use the first ejection liquid or the second ejection liquid may be determined by a user at the time of use. For example, whether the liquid ejection apparatus 11 is of a model to which the liquid container 12 containing the first ejection liquid is attached or a model to which the liquid container 12 containing the second ejection liquid is attached may be determined at the time of shipment. In the liquid ejection apparatus 11, for example, whether to attach the liquid container 12 containing the first ejection liquid or to attach the liquid container 12 containing the second ejection liquid may be determined by the user at the time of use. Therefore, the liquid ejection apparatus 11 is manufactured such that both the first ejection liquid and the second ejection liquid can be used.

The liquid ejection apparatus 11 includes an ejection unit 13. The ejection unit 13 is configured to eject a liquid. Specifically, the ejection unit 13 is configured to eject the first ejection liquid or the second ejection liquid. The ejection unit 13 is configured to be supplied with the ejection liquid from the liquid container 12. The ejection unit 13 is configured to be supplied with the first ejection liquid or the second ejection liquid from the liquid container 12.

The ejection unit 13 has a nozzle surface 15 in which one or more nozzles 14 open. The ejection unit 13 is configured to eject the ejection liquid from the nozzle 14. The ejection unit 13 prints an image on the medium by ejecting the ejection liquid onto the medium. The ejection unit 13 may be a serial head that scans the medium, or may be a line head capable of ejecting the liquid all at once over the width of the medium.

The liquid ejection apparatus 11 includes a supply unit 16. The supply unit 16 is configured to supply the ejection liquid from the liquid container 12 to the ejection unit 13. The supply unit 16 includes, for example, a supply flow path 17 that couples the liquid container 12 and the ejection unit 13. The liquid is supplied from the liquid container 12 to the ejection unit 13 through the supply flow path 17. In addition to the supply flow path 17, the supply unit 16 may include a supply pump that sends the liquid from the liquid container 12 to the ejection unit 13.

The liquid ejection apparatus 11 includes a moisturizing unit 21. The moisturizing unit 21 is configured to moisturize the ejection liquid. The ejection liquid may evaporate over time. Specifically, moisture may evaporate from the ejection liquid over time. For example, moisture may evaporate from the ejection liquid through the nozzle 14, or moisture may evaporate from the ejection liquid in the supply flow path 17. When moisture evaporates from the ejection liquid, the concentration of the ejection liquid increases. When the concentration of the ejection liquid increases, the viscosity of the ejection liquid increases. When the viscosity of the ejection liquid increases, the ejection performance of the ejection unit 13 may be affected. Therefore, the moisturizing unit 21 suppresses evaporation of the ejection liquid by moisturizing the ejection liquid.

The moisturizing unit 21 includes a reservoir section 22. The reservoir section 22 is configured to store the moisturizing liquid. The reservoir section 22 is, for example, a tank that stores the moisturizing liquid. The moisturizing liquid is a liquid for moisturizing the ejection liquid. The moisturizing liquid contains, for example, glycerin and water. The moisturizing liquid moisturizes the ejection liquid by releasing moisture.

The moisturizing unit 21 may be configured to moisturize the ejection liquid in the supply unit 16. The moisturizing unit 21 may be configured to moisturize the ejection liquid in the supply unit 16 by coming into contact with the supply unit 16. For example, the moisturizing unit 21 may be configured such that the reservoir section 22 comes into contact with the supply flow path 17 through a moisture permeable film. The moisture permeable film is a film permeated by a gas, but not permeated by a liquid. In this case, the moisture of the moisturizing liquid passes through the moisture permeable film as vapor, so that evaporation of the moisture from the ejection liquid is suppressed.

The moisturizing unit 21 may be configured to moisturize the ejection liquid in the ejection unit 13. The moisturizing unit 21 may include, for example, a cap 23. The cap 23 is configured to moisturize the ejection unit 13. The cap 23 is configured to contact the ejection unit 13. The cap 23 moisturizes the ejection unit 13 by coming into contact with the ejection unit 13. Specifically, the cap 23 comes into contact with the ejection unit 13 so as to cover the nozzle 14. In one example, the cap 23 contacts the nozzle surface 15 so as to cover the nozzle 14. Accordingly, the cap 23 moisturizes the ejection unit 13.

The cap 23 and the ejection unit 13 are configured to move closer to or away from each other. In one example, the cap 23 is configured to move with respect to the ejection unit 13. The ejection unit 13 may be configured to move with respect to the cap 23. The cap 23 and the ejection unit 13 may be configured to respectively move. The cap 23 moves closer to the ejection unit 13 when the ejection unit 13 is in the standby state. The cap 23 comes into contact with the ejection unit 13 by moving closer to the ejection unit 13. That is, the cap 23 moisturizes the ejection unit 13 when the ejection unit 13 is in a standby state. The standby state is a state of waiting for printing.

The cap 23 may be configured to receive the ejection liquid ejected from the ejection unit 13. For example, the cap 23 may be configured to receive the ejection liquid ejected from the ejection unit 13 during flushing, cleaning, or the like. The flushing is an operation of appropriately ejecting the ejection liquid from the nozzle 14 in order to prevent clogging of the nozzle 14. The cleaning is an operation of forcibly ejecting the ejection liquid from the nozzle 14 in order to eject the foreign matter in the ejection unit 13.

The cap 23 has a cap member 24. The cap member 24 is a member that contacts with the ejection unit 13. The cap member 24 is a member that contacts the nozzle surface 15. The cap member 24 is configured to define a cap space C1. The cap space C1 is a space in the cap member 24.

The cap 23 may have a partition film 25. The partition film 25 is attached to the cap member 24. The partition film 25 is located in the cap member 24. The partition film 25 is located to partition the cap space C1 into a first space C2 and a second space C3. The first space C2 is a space for moisturizing the ejection unit 13. The first space C2 is a space communicating with the nozzle .

The first space C2 is filled with moisture, thereby moisturizing the ejection unit 13. The first space C2 may be a space that receives the liquid ejected from the ejection unit 13. The second space C3 is a space to which moisture is supplied from the moisturizing liquid. The second space C3 may be a space to which the moisturizing liquid is supplied. The second space C3 may be a space in which the moisturizing liquid is stored or a space through which the moisturizing liquid passes. The second space C3 is filled with moisture by supplying moisture from the moisturizing liquid.

The partition film 25 is formed of a moisture permeable film. Therefore, the partition film 25 allows the vapor to move between the first space C2 and the second space C3. That is, moisture can move between the first space C2 and the second space C3 through the partition film 25. When moisture is supplied from the moisturizing liquid to the second space C3, the moisture is supplied from the second space C3 to the first space C2 through the partition film 25. Accordingly, when the first space C2 is filled with moisture, the ejection unit 13 is moisturized.

The partition film 25 prevents the liquid from moving between the first space C2 and the second space C3. That is, the partition film 25 suppresses the movement of the ejection liquid from the first space C2 to the second space C3 and the movement of the moisturizing liquid from the second space C3 to the first space C2. The partition film 25 reduces the possibility that the ejection liquid and the moisturizing liquid are mixed in the cap member 24.

The cap 23 may include an absorber 26. The absorber 26 is located in the cap member 24. The absorber 26 is located in the first space C2. The absorber 26 is configured to absorb the ejection liquid. The absorber 26 is configured to receive the liquid ejected from the ejection unit 13. Since the absorber 26 absorbs the ejection liquid, the possibility that the partition film 25 is blocked by the ejection liquid is reduced.

The moisturizing unit 21 may be configured to suction the ejection liquid from the first space C2. In this case, the moisturizing unit 21 can eject the ejection liquid accumulated in the first space C2 from the cap 23.

The moisturizing unit 21 may include a coupling flow path 27. The coupling flow path 27 is a flow path coupled to the reservoir section 22. The coupling flow path 27 is a flow path coupled to the cap 23. The coupling flow path 27 is a flow path that couples the reservoir section 22 and the cap 23. Moisture is supplied from the reservoir section 22 to the cap 23 through the coupling flow path 27. Moisture evaporated from the moisturizing liquid may be supplied from the reservoir section 22 to the cap 23 through the coupling flow path 27. The moisturizing liquid may be supplied from the reservoir section 22 to the cap 23 through the coupling flow path 27. In one example, the coupling flow path 27 is a flow path through which the moisturizing liquid flows.

The coupling flow path 27 may have a supply portion 28. The supply portion 28 is a portion of the coupling flow path 27 where the moisturizing liquid flows from the reservoir section 22 toward the cap 23. The moisturizing liquid is supplied from the reservoir section 22 to the cap 23 through the supply portion 28.

The coupling flow path 27 may have a collection portion 29. The collection portion 29 is a portion of the coupling flow path 27 where the moisturizing liquid flows from the cap 23 toward the reservoir section 22. The moisturizing liquid is returned from the cap 23 to the reservoir section 22 through the collection portion 29.

The moisturizing unit 21 circulates the moisturizing liquid in the reservoir section 22 and the cap 23 by the supply portion 28 and the collection portion 29. By circulating the moisturizing liquid between the reservoir section 22 and the cap 23, the inside of the cap 23 is easily filled with moisture. Furthermore, the circulation of the moisturizing liquid reduces the possibility that the concentration of the moisturizing liquid is biased.

The moisturizing unit 21 may include a flow pump 30. The flow pump 30 is located in the coupling flow path 27. The flow pump 30 is a pump that causes the moisturizing liquid to flow in the coupling flow path 27. In one example, the flow pump 30 is located in the supply portion 28. The flow pump 30 causes the moisturizing liquid to flow so as to send the moisturizing liquid from the reservoir section 22 to the cap 23 in the supply portion 28. The flow pump 30 returns the moisturizing liquid from the cap 23 to the reservoir section 22 through the collection portion 29 by sending the moisturizing liquid from the reservoir section 22 to the cap 23 through the supply portion 28. That is, the flow pump 30 is driven to circulate the moisturizing liquid in the coupling flow path 27. The flow pump 30 may be located in the collection portion 29.

The moisturizing unit 21 may include one or more check valves. In one example, the moisturizing unit 21 includes two check valves. Specifically, the moisturizing unit 21 has a first check valve 31 and a second check valve 32. The check valve is a valve that restricts the liquid flow in one direction. The check valve is located in the coupling flow path 27. The check valve restricts the flow of the liquid in the coupling flow path 27 in one direction. The first check valve 31 is located in the supply portion

Specifically, the first check valve 31 is located between the flow pump 30 and the reservoir section 22 in the supply portion 28. The first check valve 31 restricts the flow of the liquid so that the liquid flows from the reservoir section 22 toward the cap 23 in the supply portion 28. That is, the first check valve 31 prevents the liquid from flowing from the cap 23 toward the reservoir section 22 in the supply portion 28. The second check valve 32 is located in the collection portion 29. The second check valve 32 restricts the flow of the liquid so that the liquid flows from the cap 23 toward the reservoir section 22 in the collection portion 29. That is, the second check valve 32 prevents the liquid from flowing from the reservoir section 22 toward the cap 23 in the collection portion 29.

The moisturizing liquid evaporates when moisturizing the ejection liquid. The moisturizing liquid evaporates by releasing moisture. When the moisturizing liquid evaporates, the moisture content of the moisturizing liquid decreases. When the moisture content of the moisturizing liquid decreases, the concentration of the moisturizing liquid increases. When the concentration of the moisturizing liquid increases, the ejection liquid may not be moisturized.

For moisturization of the ejection liquid by the moisturizing liquid, the concentration of the moisturizing liquid is important. Specifically, the concentration of the moisturizing liquid with respect to the concentration of the ejection liquid is important. When the concentration of the moisturizing liquid is higher with respect to the concentration of the ejection liquid, moisture easily moves from the ejection liquid to the moisturizing liquid. When moisture moves from the ejection liquid to the moisturizing liquid, the amount of moisture in the ejection liquid may be insufficient. That is, evaporation of the ejection liquid may be promoted. In contrast, when the concentration of the moisturizing liquid is lower with respect to the concentration of the ejection liquid, moisture easily moves from the moisturizing liquid to the ejection liquid. When moisture moves from the moisturizing liquid to the ejection liquid, the amount of moisture in the ejection liquid may be excessive. Also in this case, the ejection performance of the ejection unit 13 may be affected or the print quality may be affected.

In the moisturizing unit 21, it is important to control the concentration of the moisturizing liquid. Specifically, in the moisturizing unit 21, it is important to adjust the concentration of the moisturizing liquid in accordance with the ejection liquid. For example, in the moisturizing unit 21, it is important to adjust the concentration of the moisturizing liquid so as to balance the moisturizing power of the ejection liquid and the moisturizing power of the moisturizing liquid. For example, in the moisturizing unit 21, it is important to adjust the concentration of the moisturizing liquid so that the vapor pressure of the ejection liquid and the vapor pressure of the moisturizing liquid are balanced. In this way, the ejection liquid is appropriately moisturized.

The moisturizing unit 21 includes an adjustment section 41. The adjustment section 41 is configured to adjust the concentration of the moisturizing liquid. The adjustment section 41 adjusts the concentration of the moisturizing liquid stored in the reservoir section 22. The adjustment section 41 adjusts the concentration of the moisturizing liquid in accordance with the ejection liquid to be used. The adjustment section 41 maintains the concentration of the moisturizing liquid in accordance with the ejection liquid to be used. Specifically, the adjustment section 41 maintains the concentration of the moisturizing liquid by supplying moisture to the moisturizing liquid.

The adjustment section 41 includes a supply mechanism 42. The supply mechanism 42 is configured to supply moisture to the moisturizing liquid. Specifically, the supply mechanism 42 is configured to supply a replenishment liquid to the moisturizing liquid. The supply mechanism 42 supplies the replenishment liquid to the moisturizing liquid by supplying the replenishment liquid to the reservoir section 22. The replenishment liquid is a liquid for replenishing moisture to the moisturizing liquid. The replenishment liquid is a liquid containing a solvent of the moisturizing liquid. In one example, the replenishment liquid is water.

The supply mechanism 42 includes a replenishment tank 43. The replenishment tank 43 is configured to store the replenishment liquid. The replenishment tank 43 is coupled to the reservoir section 22. The supply mechanism 42 is configured to supply the replenishment liquid from the replenishment tank 43 to the reservoir section 22.

The supply mechanism 42 has a replenishment flow path 44. The replenishment flow path 44 is coupled to the replenishment tank 43. The replenishment flow path 44 is coupled to the reservoir section 22. The replenishment flow path 44 couples the replenishment tank 43 and the reservoir section 22. The replenishment flow path 44 is a flow path through which the replenishment liquid flows. The replenishment liquid flows from the replenishment tank 43 to the reservoir section 22 through the replenishment flow path 44.

The replenishment flow path 44 may be configured to share a part with the coupling flow path 27. For example, the replenishment flow path 44 may extend so as to join the coupling flow path 27. In one example, the replenishment flow path 44 extends so as to join the supply portion 28. The replenishment flow path 44 includes a part of the coupling flow path 27 and the cap 23. The replenishment liquid passes through the supply portion 28, the cap 23, and the collection portion 29 in this order in the replenishment flow path 44, and is thereby supplied to the reservoir section 22. The replenishment flow path 44 may be an independent flow path separate from the coupling flow path 27.

The supply mechanism 42 may have an on-off valve 45. The on-off valve 45 is located in the replenishment flow path 44. The on-off valve 45 is configured to open and close the replenishment flow path 44. When the on-off valve 45 is opened, the replenishment liquid can be supplied from the replenishment tank 43 to the reservoir section 22 through the replenishment flow path 44. The on-off valve 45 is located in the replenishment flow path 44. In one example, the on-off valve 45 is located in a portion of the replenishment flow path 44, which is not shared with the coupling flow path 27. That is, the on-off valve 45 is located between the joint with the supply portion 28 and the replenishment tank 43 in the replenishment flow path 44.

The supply mechanism 42 may have a one-way valve 46. Similarly to the check valve, the one-way valve 46 is a valve that restricts the flow of the liquid in one direction. The one-way valve 46 is located in the replenishment flow path 44. In one example, the one-way valve 46 is located between the replenishment tank 43 and the on-off valve 45 in the replenishment flow path 44. The one-way valve 46 restricts the flow of the liquid in the replenishment flow path 44 in one direction. The one-way valve 46 restricts the flow of the liquid so that the liquid flows from the replenishment tank 43 toward the reservoir section 22 in the replenishment flow path 44. That is, the one-way valve 46 prevents the liquid from flowing from the reservoir section 22 toward the replenishment tank 43 in the replenishment flow path 44. In one example, the one-way valve 46 also prevents the liquid from flowing from the cap 23 toward the replenishment tank 43 in the replenishment flow path 44.

The supply mechanism 42 may have a replenishment pump 47. The replenishment pump 47 is a pump that supplies the replenishment liquid from the replenishment tank 43 to the reservoir section 22. The replenishment pump 47 is located in the replenishment flow path 44. The replenishment pump 47 may be a pump common to the flow pump 30. In one example, the flow pump 30 also serves as the replenishment pump 47. Therefore, the replenishment pump 47 that is also the flow pump 30 is located in a shared portion between the replenishment flow path 44 and the coupling flow path 27. Specifically, the replenishment pump 47 is located between the joint with the coupling flow path 27 and the cap 23 in the replenishment flow path 44.

The adjustment section 41 includes a liquid level sensor 48. The liquid level sensor 48 is configured to detect the liquid level of the moisturizing liquid stored in the reservoir section 22. Specifically, the liquid level sensor 48 is configured to detect that the liquid level of the moisturizing liquid is a reference liquid level L1. The reference liquid level L1 is a liquid level as a reference for the liquid amount of the moisturizing liquid stored in the reservoir section 22. The reference liquid level L1 is a liquid level as a reference for adjustment of the concentration of the moisturizing liquid.

The liquid level sensor 48 may have one or more electrodes. The liquid level sensor 48 includes, for example, a reference electrode 49 and a liquid level electrode 50. The reference electrode 49 and the liquid level electrode 50 are attached to the reservoir section 22. The reference electrode 49 and the liquid level electrode 50 extend from the ceiling of the reservoir section 22 toward the bottom of the reservoir section 22. The reference electrode 49 is longer than the liquid level electrode 50. Therefore, the distance between the tip of the reference electrode 49 and the bottom of the reservoir section 22 is smaller than the distance between the tip of the liquid level electrode 50 and the bottom of the reservoir section 22. The liquid level electrode 50 is an electrode that defines the reference liquid level L1. The tip position of the liquid level electrode 50 coincides with the reference liquid level L1. The liquid level electrode 50 detects the moisturizing liquid by coming into contact with the moisturizing liquid. That is, the liquid level electrode 50 detects the reference liquid level L1 by coming into contact with the moisturizing liquid.

The liquid level sensor 48 detects the liquid level of the moisturizing liquid based on conduction between the reference electrode 49 and the liquid level electrode 50. Specifically, the liquid level sensor 48 detects that the liquid level of the moisturizing liquid is the reference liquid level L1 based on conduction between the reference electrode 49 and the liquid level electrode 50. When the liquid level of the moisturizing liquid is equal to or higher than the reference liquid level L1, both the reference electrode 49 and the liquid level electrode 50 come into contact with the moisturizing liquid. In this case, the reference electrode 49 and the liquid level electrode 50 are conductive. When the liquid level of the moisturizing liquid is lower than the reference liquid level L1, the liquid level electrode 50 does not come into contact with the moisturizing liquid. In this case, the reference electrode 49 and the liquid level electrode 50 are not conductive. That is, the liquid level sensor 48 detects that the liquid level of the moisturizing liquid is the reference liquid level L1 by the reference electrode 49 and the liquid level electrode 50 changing from the non-conductive state to the conductive state. The liquid level sensor 48 detects that the liquid amount of the moisturizing liquid is a first liquid amount by detecting that the liquid level of the moisturizing liquid is the reference liquid level L1.

The liquid level sensor 48 is not limited to detecting the liquid level using conduction between the electrodes, and may detect the liquid level by measuring the distance to the liquid surface by a laser, for example. The liquid level sensor 48 may be configured to detect the liquid level by, for example, time of flight.

The moisturizing unit 21 may include a controller 51. The controller 51 is configured to control the moisturizing unit 21. The controller 51 is configured to control the adjustment section 41. The controller 51 may be configured to control the supply mechanism 42 and the liquid level sensor 48. The controller 51 may be configured to control the ejection unit 13, the supply unit 16, and the like in addition to the moisturizing unit 21. The controller 51 is configured to control the liquid ejection apparatus 11.

The controller 51 may include one or more processors that execute various kinds of processing according to a computer program. The controller 51 may be configured with one or more dedicated hardware circuits such as an ASIC that executes at least part of the various kinds of processing. The controller 51 may include a circuit including a combination of a processor and a hardware circuit. The processor includes a CPU and a memory such as a RAM and a ROM. The memory stores program codes or commands configured to cause the CPU to perform the processing. A memory, that is, a computer-readable medium includes all readable media that can be accessed by a general-purpose or dedicated computer.

The controller 51 adjusts the concentration of the moisturizing liquid by controlling the adjustment section 41. The controller 51 adjusts the concentration of the moisturizing liquid by controlling the supply mechanism 42 based on the detection result of the liquid level sensor 48. The controller 51 maintains the concentration of the moisturizing liquid by supplying the replenishment liquid to the reservoir section 22 so as to maintain the liquid level of the moisturizing liquid based on the detection result of the liquid level sensor 48. Specifically, the controller 51 controls the adjustment section 41 to set the amount of the moisturizing liquid to a predetermined liquid amount based on the reference liquid level L1. The controller 51 controls the adjustment section 41 to supply the replenishment liquid to the moisturizing liquid so that the amount of the moisturizing liquid is the predetermined liquid amount based on the reference liquid level L1. For example, the controller 51 supplies the replenishment liquid to the moisturizing liquid so as to replenish the moisture evaporated from the moisturizing liquid. By maintaining the liquid amount of the moisturizing liquid stored in the reservoir section 22 constant, the concentration of the moisturizing liquid is maintained constant.

The controller 51 may fill the reservoir section 22 with the moisturizing liquid by controlling the adjustment section 41. Filling with the moisturizing liquid is performed before shipment of the liquid ejection apparatus 11, before use of the liquid ejection apparatus 11, or the like. The program for filling with the moisturizing liquid may be stored in the memory of the controller 51. The filling with the moisturizing liquid may be executed by controlling the adjustment section 41 by an external controller.

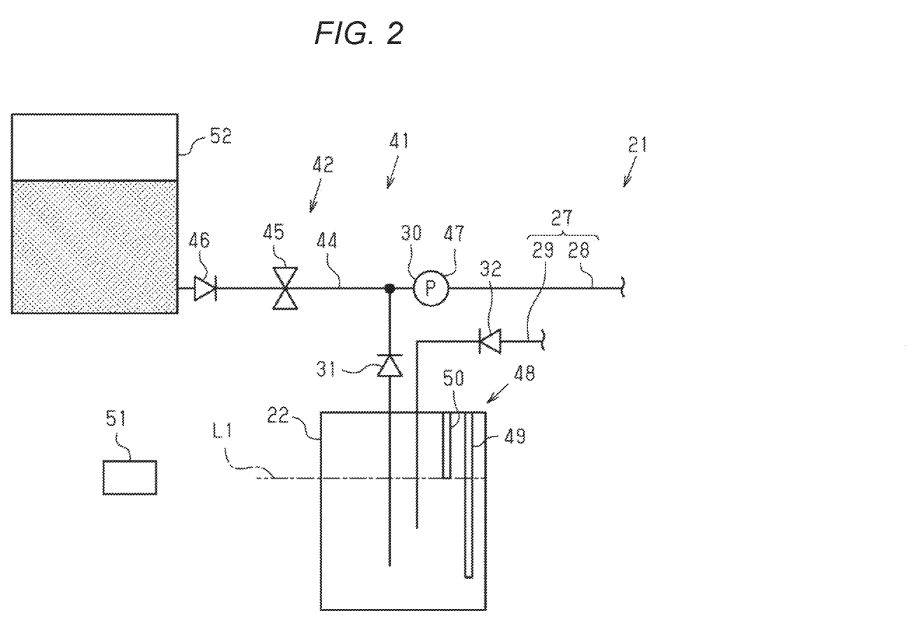

As shown in FIG. 2, in the filling with the moisturizing liquid, a moisturizing liquid container 52 is attached to the replenishment flow path 44. Specifically, in the moisturizing unit 21, the moisturizing liquid container 52 is coupled to the replenishment flow path 44 instead of the replenishment tank 43. The moisturizing liquid container 52 is configured to contain the moisturizing liquid. The moisturizing liquid container 52 contains the moisturizing liquid having a predetermined concentration. The moisturizing liquid container 52 may contain the moisturizing liquid having a concentration corresponding to the first ejection liquid or may contain the moisturizing liquid having a concentration corresponding to the second ejection liquid. The moisturizing liquid container 52 may be a tank, a pack, or a cartridge.

The controller 51 opens the on-off valve 45 for filling with the moisturizing liquid. The controller 51 drives the replenishment pump 47 with the on-off valve 45 opened. Accordingly, the moisturizing liquid is supplied from the moisturizing liquid container 52 to the reservoir section 22.

The controller 51 fills the reservoir section 22 with a predetermined amount of moisturizing liquid based on the detection result of the liquid level sensor 48. For example, the controller 51 fills the reservoir section 22 with the moisturizing liquid until the liquid level of the moisturizing liquid becomes the reference liquid level L1. In this case, the controller 51 drives the replenishment pump 47 until the liquid level sensor 48 detects that the liquid level of the moisturizing liquid is the reference liquid level L1. When the liquid level sensor 48 detects the reference liquid level L1, the controller 51 closes the on-off valve 45 and stops the replenishment pump 47. Accordingly, at the time of filling with the moisturizing liquid, the moisturizing liquid is stored in the reservoir section 22 at the reference liquid level L1. That is, at the time of filling with the moisturizing liquid, the moisturizing liquid is stored in the reservoir section 22 in the first liquid amount. At the time of using the moisturizing liquid, the controller 51 maintains the concentration of the moisturizing liquid in the state at the time of filling by supplying the replenishment liquid so as to maintain the moisturizing liquid at the reference liquid level L1. That is, at the time of using the moisturizing liquid, the controller 51 maintains the concentration of the moisturizing liquid in the state at the time of filling by supplying the replenishment liquid so as to maintain the moisturizing liquid in the first liquid amount.

The controller 51 may fill with the moisturizing liquid such that the liquid amount of the moisturizing liquid is larger than that at the reference liquid level L1. For example, the controller 51 may fill with the moisturizing liquid such that the liquid level of the moisturizing liquid is higher than the reference liquid level L1. After the liquid level sensor 48 detects that the liquid level of the moisturizing liquid is the reference liquid level L1, the controller 51 may further drive the replenishment pump 47 to fill with the moisturizing liquid such that the liquid amount of the moisturizing liquid is larger than that when the liquid level is the reference liquid level L1. That is, after the liquid level sensor 48 detects that the liquid amount of the moisturizing liquid is the first liquid amount, the controller 51 may further drive the replenishment pump 47 to fill with the moisturizing liquid so that the liquid amount of the moisturizing liquid becomes a second liquid amount larger than the first liquid amount. At the time of using the moisturizing liquid, the controller 51 may maintain the concentration of the moisturizing liquid in the state at the time of filling by supplying the replenishment liquid so as to maintain the state in which the liquid amount of the moisturizing liquid is larger than that at the time of the reference liquid level L1. That is, at the time of using the moisturizing liquid, the controller 51 may maintain the concentration of the moisturizing liquid in the state at the time of filling by supplying the replenishment liquid so as to maintain the moisturizing liquid in the second liquid amount larger than the first liquid amount.

The controller 51 may be configured to acquire the type of the ejection liquid to be used. The controller 51 may be configured to acquire whether the ejection liquid to be used is the first ejection liquid or the second ejection liquid. For example, the controller 51 may acquire the type of the ejection liquid from the liquid container 12 attached to the liquid ejection apparatus 11. Normally, an electronic substrate on which information on the ejection liquid to be contained is recorded is attached to the liquid container 12. The controller 51 may acquire the type of the ejection liquid from the electronic substrate. For example, the controller 51 may acquire the type of the ejection liquid to be used from the user. For example, the controller 51 may acquire the type of the ejection liquid from the user by the user operating a touch panel provided in the liquid ejection apparatus 11.

The concentration of the moisturizing liquid suitable for moisturizing is different between the first ejection liquid and the second ejection liquid. In one example, the concentration of the moisturizing liquid suitable for moisturizing the first ejection liquid is higher than the concentration of the moisturizing liquid suitable for moisturizing the second ejection liquid. When the liquid ejection apparatus 11 uses the first ejection liquid, it is necessary to use the moisturizing liquid having an appropriate concentration for moisturizing the first ejection liquid. When the liquid ejection apparatus 11 uses the second ejection liquid, it is necessary to use the moisturizing liquid having an appropriate concentration for moisturizing the second ejection liquid. However, it is complicated to prepare both the moisturizing liquid having the concentration suitable for moisturizing the first ejection liquid and the moisturizing liquid having the concentration suitable for moisturizing the second ejection liquid. For example, it is complicated to prepare the moisturizing liquid container 52 that contains the moisturizing liquid having the concentration suitable for moisturizing the first ejection liquid or to prepare the moisturizing liquid container 52 that contains the moisturizing liquid having the concentration suitable for moisturizing the second ejection liquid. Furthermore, when the ejection liquid to be used is switched between the first ejection liquid and the second ejection liquid, it is complicated to refill the reservoir section 22 with the moisturizing liquid having the concentration suitable for moisturizing the first ejection liquid and the moisturizing liquid having the concentration suitable for moisturizing the second ejection liquid.

The adjustment section 41 is configured to adjust the concentration of the moisturizing liquid to the concentration suitable for moisturizing the first ejection liquid and the concentration suitable for moisturizing the second ejection liquid. The adjustment section 41 is configured to maintain the moisturizing liquid at the concentration suitable for moisturizing the first ejection liquid or maintain the moisturizing liquid at the concentration suitable for moisturizing the second ejection liquid. The adjustment section 41 may be configured to maintain the moisturizing liquid having the concentration suitable for moisturizing the first ejection liquid at the same concentration or to adjust the moisturizing liquid to the concentration suitable for moisturizing the second ejection liquid. The adjustment section 41 may be configured to maintain the moisturizing liquid having the concentration suitable for moisturizing the second ejection liquid at the same concentration or to adjust the moisturizing liquid to the concentration suitable for moisturizing the first ejection liquid. In this manner, the adjustment section 41 adjusts the concentration of the moisturizing liquid so as to correspond to the moisturizing of the first ejection liquid and the moisturizing of the second ejection liquid with the single moisturizing liquid.

The adjustment section 41 adjusts the concentration of the moisturizing liquid by adjusting the liquid amount of the moisturizing liquid stored in the reservoir section 22 in accordance with the ejection liquid to be moisturized. The adjustment section 41 adjusts the liquid amount of the moisturizing liquid by controlling the supply of the replenishment liquid. For example, the adjustment section 41 decreases the concentration of the moisturizing liquid by supplying the replenishment liquid to the reservoir section 22 such that the liquid amount of the moisturizing liquid increases. For example, the adjustment section 41 increases the concentration of the moisturizing liquid by supplying the replenishment liquid to the reservoir section 22 such that the liquid amount of the moisturizing liquid decreases. As described above, the adjustment section 41 adjusts the concentration of the moisturizing liquid by supplying the replenishment liquid so as to maintain the liquid amount at the time of replenishment or supplying the replenishment liquid so as to maintain the liquid amount different from the liquid amount at the time of replenishment.

When the moisturizing liquid moisturizes the first ejection liquid, the supply mechanism 42 supplies the replenishment liquid to the reservoir section 22 so as to maintain the moisturizing liquid at the reference liquid level L1. The concentration of the moisturizing liquid is maintained by maintaining the moisturizing liquid at the reference liquid level L1. For example, when the reference liquid level L1 is the liquid level at the time of filling, the concentration of the moisturizing liquid is maintained in the state at the time of filling. Accordingly, the moisturizing liquid moisturizes the first ejection liquid.

When the moisturizing liquid moisturizes the first ejection liquid, the supply mechanism 42 supplies the replenishment liquid to the reservoir section 22 so as to maintain the moisturizing liquid in the first liquid amount by maintaining the moisturizing liquid at the reference liquid level L1. The first liquid amount is a liquid amount when the reservoir section 22 is at the reference liquid level L1. The concentration of the moisturizing liquid is maintained by maintaining the moisturizing liquid in the first liquid amount. For example, when the first liquid amount is the liquid amount at the time of filling, the concentration of the moisturizing liquid is maintained in the state at the time of filling. Accordingly, the moisturizing liquid moisturizes the first ejection liquid.

When the moisturizing liquid moisturizes the second ejection liquid, the supply mechanism 42 supplies the replenishment liquid to the reservoir section 22 such that the amount of the moisturizing liquid stored in the reservoir section 22 is maintained to be larger than that when the moisturizing liquid moisturizes the first ejection liquid. By maintaining the state in which the liquid amount of the moisturizing liquid stored in the reservoir section 22 is larger than that when the moisturizing liquid moisturizes the first ejection liquid, the state in which the concentration is lower than that when the moisturizing liquid moisturizes the first ejection liquid is maintained. For example, the concentration of the moisturizing liquid is maintained to be lower than that at the time of filling. Accordingly, the moisturizing liquid moisturizes the second ejection liquid.

When the moisturizing liquid moisturizes the second ejection liquid, the supply mechanism 42 supplies the replenishment liquid to the reservoir section 22 so as to maintain the moisturizing liquid in the second liquid amount larger than the first liquid amount. By maintaining the moisturizing liquid in the second liquid amount larger than the first liquid amount, the concentration of the moisturizing liquid is maintained to be lower than that when the moisturizing liquid moisturizes the first ejection liquid. For example, the concentration of the moisturizing liquid is maintained to be lower than that at the time of filling. Accordingly, the moisturizing liquid moisturizes the second ejection liquid.

The supply mechanism 42 adjusts the concentration of the moisturizing liquid by supplying the replenishment liquid to the reservoir section 22 so as to maintain the moisturizing liquid in the first liquid amount or the second liquid amount. Accordingly, the moisturizing unit 21 can moisturize the first ejection liquid and the second ejection liquid with the single moisturizing liquid.

Hereinafter, embodiments of the moisturizing unit 21 that adjusts the moisturizing liquid to the concentration suitable for moisturizing the first ejection liquid and the concentration suitable for moisturizing the second ejection liquid will be described. In each embodiment, a specific configuration and method of supplying the replenishment liquid for adjusting the concentration of the moisturizing liquid will be described.

### First Embodiment

First, a first embodiment of the moisturizing unit 21 will be described. In the first embodiment, the reservoir section 22 is filled with a moisturizing liquid having a concentration suitable for moisturizing the first ejection liquid.

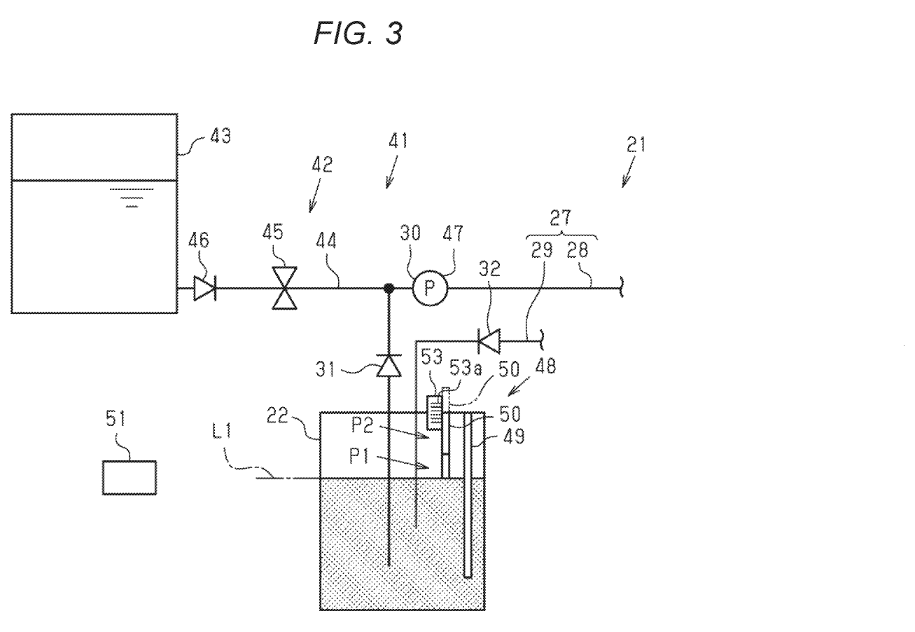

As shown in FIG. 3, the adjustment section 41 includes a lifting mechanism 53. The lifting mechanism 53 is configured to lift and lower the liquid level electrode 50. The lifting mechanism 53 may include a slider to which the liquid level electrode 50 is attached, a ball screw, or the like. The lifting mechanism 53 may be configured to automatically displace the liquid level electrode 50 by driving a motor, or may be configured to manually displace the liquid level electrode 50. The lifting mechanism 53 may have a scale 53a indicating the height of the liquid level electrode 50.

The lifting mechanism 53 lifts and lowers the liquid level electrode 50 so as to be displaced between a first position P1 and a second position P2. The lifting mechanism 53 displaces the liquid level electrode 50 from the first position P1 to the second position P2 by lifting the liquid level electrode 50. The lifting mechanism 53 displaces the liquid level electrode 50 from the second position P2 to the first position P1 by lowering the liquid level electrode 50.

When the moisturizing liquid moisturizes the first ejection liquid, the lifting mechanism 53 positions the liquid level electrode 50 at the first position P1. When the moisturizing liquid moisturizes the second ejection liquid, the lifting mechanism 53 positions the liquid level electrode 50 at the second position P2.

The first position P1 is a position that defines the reference liquid level L1. The first position P1 is a position where it is detected that the moisturizing liquid is at the reference liquid level L1. When the liquid level electrode 50 is located at the first position P1, the liquid level sensor 48 detects that the moisturizing liquid is at the reference liquid level L1. The first position P1 is a position where the liquid level electrode 50 detects that the moisturizing liquid is in the first liquid amount. When the liquid level electrode 50 is located at the first position P1, the liquid level sensor 48 detects that the moisturizing liquid is in the first liquid amount.

The second position P2 is a position above the first position P1. The second position P2 is a position where it is detected that the moisturizing liquid is at a liquid level higher than the reference liquid level L1. When the liquid level electrode 50 is located at the second position P2, the liquid level sensor 48 detects that the amount of the moisturizing liquid is larger than that when the moisturizing liquid is at the reference liquid level L1. The second position P2 is a position where the liquid level electrode 50 detects that the moisturizing liquid is in the second liquid amount. The liquid level sensor 48 detects that the moisturizing liquid is in the second liquid amount when the liquid level electrode 50 is located at the second position P2.

When the moisturizing liquid moisturizes the first ejection liquid, the supply mechanism 42 supplies the replenishment liquid to the reservoir section 22 to maintain the state in which the liquid level electrode 50 located at the first position P1 detects the moisturizing liquid. That is, when the moisturizing liquid moisturizes the first ejection liquid, the supply mechanism 42 supplies the replenishment liquid to the reservoir section 22 so as to maintain the moisturizing liquid at the reference liquid level L1. When the moisturizing liquid moisturizes the first ejection liquid, the supply mechanism 42 supplies the replenishment liquid to the reservoir section 22 so as to maintain the first liquid amount. Accordingly, the concentration of the moisturizing liquid is maintained in the state at the time of filling.

When the moisturizing liquid moisturizes the second ejection liquid, the supply mechanism 42 supplies the replenishment liquid to the reservoir section 22 to maintain the state in which the liquid level electrode 50 located at the second position P2 detects the moisturizing liquid. That is, when the moisturizing liquid moisturizes the second ejection liquid, the supply mechanism 42 supplies the replenishment liquid to the reservoir section 22 so as to maintain the state in which the liquid amount is larger than that when the moisturizing liquid is maintained at the reference liquid level L1. When the moisturizing liquid moisturizes the second ejection liquid, the supply mechanism 42 supplies the replenishment liquid to the reservoir section 22 so as to maintain the second liquid amount. Accordingly, the concentration of the moisturizing liquid is maintained to be lower than that at the time of filling.

The supply mechanism 42 supplies the replenishment liquid to the reservoir section 22 so as to maintain the state in which the liquid level electrode 50 detects the moisturizing liquid. That is, when the liquid level of the moisturizing liquid falls below the liquid level electrode 50, the supply mechanism 42 supplies the replenishment liquid such that the liquid level of the moisturizing liquid reaches the liquid level electrode 50. At each time when the liquid level electrode 50 does not detect the moisturizing liquid, the supply mechanism 42 supplies the replenishment liquid to the reservoir section 22 until the liquid level electrode 50 detects the moisturizing liquid. Therefore, by displacing the liquid level electrode 50, the moisturizing liquid is adjusted to a concentration corresponding to the position of the liquid level electrode 50. As described above, the supply mechanism 42 adjusts the concentration of the moisturizing liquid by supplying the replenishment liquid in accordance with the liquid level electrode 50 located at the first position P1 and supplying the replenishment liquid in accordance with the liquid level electrode 50 located at the second position P2.

In the first embodiment, the supply mechanism 42 may fill the reservoir section 22 with the moisturizing liquid having a concentration suitable for moisturizing the second ejection liquid. In this case, the supply mechanism 42 fills with the moisturizing liquid such that the liquid level of the moisturizing liquid reaches the liquid level electrode 50 located at the second position P2. When the moisturizing liquid is used, the supply mechanism 42 maintains the concentration of the moisturizing liquid in the state at the time of filling by supplying the replenishment liquid to maintain the state in which the liquid level electrode 50 positioned at the second position P2 detects the moisturizing liquid. When the moisturizing liquid is used, the supply mechanism 42 maintains the concentration of the moisturizing liquid higher than that at the time of filling by supplying the replenishment liquid to maintain the state in which the liquid level electrode 50 located at the first position P1 detects the moisturizing liquid. Specifically, the supply mechanism 42 maintains the concentration of the moisturizing liquid higher than that at the time of filling by supplying the replenishment liquid so as to maintain the state in which the liquid level coincides with the tip of the liquid level electrode 50 located at the first position P1. That is, the supply mechanism 42 supplies the replenishment liquid so as to maintain the state in which the liquid amount of the moisturizing liquid is smaller than that at the time of filling.

### Functions and Effects of First Embodiment

Next, the functions and effects of the first embodiment will be described.

(1-1) When the moisturizing liquid moisturizes the first ejection liquid, the supply mechanism 42 supplies the replenishment liquid to the reservoir section 22 so as to maintain the moisturizing liquid in the first liquid amount by maintaining the moisturizing liquid at the reference liquid level L1. When the moisturizing liquid moisturizes the second ejection liquid, the supply mechanism 42 supplies the replenishment liquid to the reservoir section 22 so as to maintain the moisturizing liquid in the second liquid amount larger than the first liquid amount. According to the above configuration, by maintaining the moisturizing liquid in the first liquid amount, the concentration of the moisturizing liquid is maintained constant. Accordingly, the moisturizing liquid moisturizes the first ejection liquid. By maintaining the moisturizing liquid in the second liquid amount, the concentration of the moisturizing liquid is maintained to be lower than that when the moisturizing liquid moisturizes the first ejection liquid. Accordingly, the moisturizing liquid moisturizes the second ejection liquid. As described above, the supply mechanism 42 adjusts the concentration of the moisturizing liquid by supplying the replenishment liquid so as to maintain the moisturizing liquid in the first liquid amount or the second liquid amount. Therefore, the moisturizing unit 21 can moisturize the first ejection liquid and the second ejection liquid with the single moisturizing liquid.

(1-2) When the moisturizing liquid moisturizes the first ejection liquid, the supply mechanism 42 supplies the replenishment liquid to the reservoir section 22 to maintain the state in which the liquid level electrode 50 located at the first position P1 detects the moisturizing liquid. When the moisturizing liquid moisturizes the second ejection liquid, the supply mechanism 42 supplies the replenishment liquid to the reservoir section 22 to maintain the state in which the liquid level electrode 50 located at the second position P2 detects the moisturizing liquid. According to the above configuration, the moisturizing unit 21 can adjust the concentration of the moisturizing liquid by supplying the replenishment liquid in accordance with the liquid level electrode 50 located at the first position P1 or supplying the replenishment liquid in accordance with the liquid level electrode 50 located at the second position P2.

(1-3) The moisturizing unit 21 includes the cap 23 and the coupling flow path 27. According to the above configuration, moisture is supplied from the moisturizing liquid to the cap 23 through the coupling flow path 27, and thus the liquid in the ejection unit 13 can be moisturized.

(1-4) The coupling flow path 27 includes the supply portion 28 and the collection portion 29. According to the above configuration, the moisturizing liquid can be circulated between the reservoir section 22 and the cap 23. Accordingly, the concentration of the moisturizing liquid is easily maintained to be uniform.

### Second Embodiment

Next, a second embodiment of the moisturizing unit 21 will be described. In the second embodiment, the reservoir section 22 is filled with the moisturizing liquid having a concentration suitable for moisturizing the first ejection liquid.

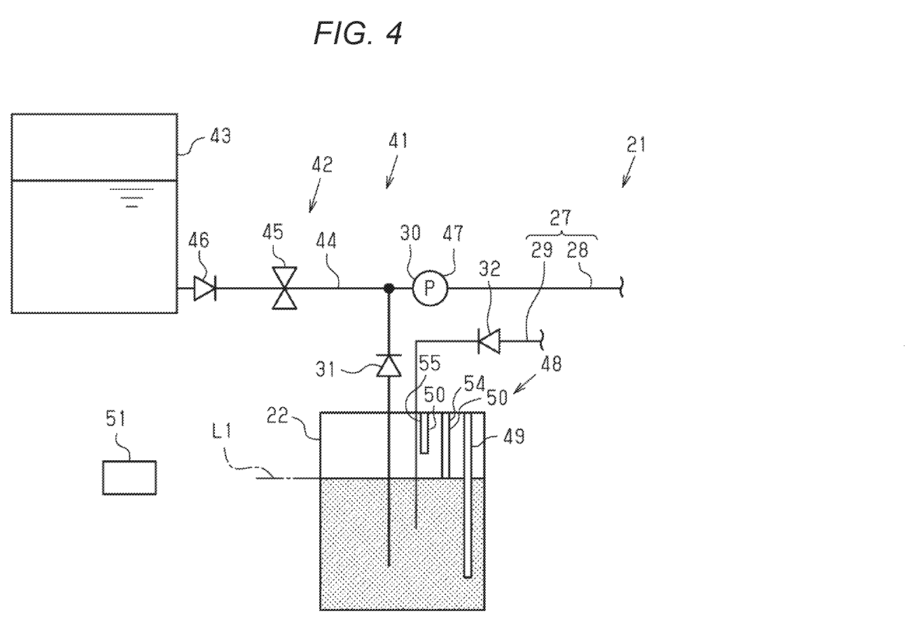

As shown in FIG. 4, the liquid level sensor 48 has a plurality of the liquid level electrodes 50. Specifically, the liquid level sensor 48 includes a first liquid level electrode 54 and a second liquid level electrode 55. The first liquid level electrode 54 is an electrode longer than the second liquid level electrode 55. Therefore, the distance between the tip of the first liquid level electrode 54 and the bottom of the reservoir section 22 is smaller than the distance between the tip of the second liquid level electrode 55 and the bottom of the reservoir section 22.

The first liquid level electrode 54 is an electrode that defines the reference liquid level L1. The first liquid level electrode 54 is an electrode that detects that the moisturizing liquid is at the reference liquid level L1. The liquid level sensor 48 detects that the moisturizing liquid is at the reference liquid level L1 by conduction between the reference electrode 49 and the first liquid level electrode 54. The first liquid level electrode 54 is an electrode that detects that the moisturizing liquid is in the first liquid amount. The liquid level sensor 48 detects that the moisturizing liquid is in the first liquid amount by conduction between the reference electrode 49 and the first liquid level electrode 54.

The second liquid level electrode 55 is an electrode that detects that the moisturizing liquid is at a liquid level higher than the reference liquid level L1. The liquid level sensor 48 detects that the moisturizing liquid is at the liquid level higher than the reference liquid level L1 by conduction between the reference electrode 49 and the second liquid level electrode 55. That is, the liquid level sensor 48 detects that the moisturizing liquid is stored in a liquid amount larger than that when the moisturizing liquid is at the reference liquid level L1 by conduction between the reference electrode 49 and the second liquid level electrode 55. The second liquid level electrode 55 detects that the moisturizing liquid is in the second liquid amount. The liquid level sensor 48 detects that the moisturizing liquid is in the second liquid amount by conduction between the reference electrode 49 and the second liquid level electrode 55.

When the moisturizing liquid moisturizes the first ejection liquid, the supply mechanism 42 supplies the replenishment liquid to the reservoir section 22 so as to maintain the state in which the first liquid level electrode 54 detects the moisturizing liquid. That is, when the moisturizing liquid moisturizes the first ejection liquid, the supply mechanism 42 supplies the replenishment liquid to the reservoir section 22 so as to maintain the moisturizing liquid at the reference liquid level L1. When the moisturizing liquid moisturizes the first ejection liquid, the supply mechanism 42 supplies the replenishment liquid to the reservoir section 22 so as to maintain the moisturizing liquid in the first liquid amount. When the liquid level of the moisturizing liquid falls below the first liquid level electrode 54, the supply mechanism 42 supplies the replenishment liquid such that the liquid level of the moisturizing liquid reaches the first liquid level electrode 54. Accordingly, the concentration of the moisturizing liquid is maintained in the state at the time of filling.

When the moisturizing liquid moisturizes the second ejection liquid, the supply mechanism 42 supplies the replenishment liquid to the reservoir section 22 so as to maintain the state in which the second liquid level electrode 55 detects the moisturizing liquid. That is, when the moisturizing liquid moisturizes the second ejection liquid, the supply mechanism 42 supplies the replenishment liquid to the reservoir section 22 so as to maintain the state in which the liquid amount is larger than that when the moisturizing liquid is maintained at the reference liquid level L1. When the moisturizing liquid moisturizes the second ejection liquid, the supply mechanism 42 supplies the replenishment liquid to the reservoir section 22 so as to maintain the moisturizing liquid in the second liquid amount. When the liquid level of the moisturizing liquid falls below the second liquid level electrode 55, the supply mechanism 42 supplies the replenishment liquid such that the liquid level of the moisturizing liquid reaches the second liquid level electrode 55. Accordingly, the concentration of the moisturizing liquid is maintained to be lower than that at the time of filling.

The moisturizing unit 21 adjusts the moisturizing liquid at a concentration corresponding to the length of the liquid level electrode 50 by changing the liquid level electrode 50 to be used according to the ejection liquid to be used. The moisturizing unit 21 can adjust the concentration of the moisturizing liquid by supplying the replenishment liquid in accordance with the first liquid level electrode 54 or supplying the replenishment liquid in accordance with the second liquid level electrode 55.

In the second embodiment, the supply mechanism 42 may fill the reservoir section 22 with the moisturizing liquid having the concentration suitable for moisturizing the second ejection liquid. In this case, the supply mechanism 42 fills with the moisturizing liquid such that the liquid level of the moisturizing liquid reaches the second liquid level electrode 55. At the time of using the moisturizing liquid, the supply mechanism 42 maintains the concentration of the moisturizing liquid in the state at the time of filling by supplying the replenishment liquid to maintain the second liquid level electrode 55 detects the moisturizing liquid. At the time of using the moisturizing liquid, the supply mechanism 42 supplies the replenishment liquid so as to maintain the state in which the first liquid level electrode 54 detects the moisturizing liquid, thereby maintaining the concentration of the moisturizing liquid higher than that at the time of filling. Specifically, the supply mechanism 42 maintains the concentration of the moisturizing liquid higher than that at the time of filling by supplying the replenishment liquid so as to maintain the state in which the liquid level coincides with the tip of the first liquid level electrode 54. That is, the supply mechanism 42 supplies the replenishment liquid so as to maintain the state in which the liquid amount of the moisturizing liquid is smaller than that at the time of filling.

### Functions and Effects of Second Embodiment

Then, the functions and effects of the second embodiment will be described. According to the second embodiment, the following functions and effects are obtained in addition to (1-1), (1-3), and (1-4).

(2-1) When the moisturizing liquid moisturizes the first ejection liquid, the supply mechanism 42 supplies the replenishment liquid to the reservoir section 22 so as to maintain the state in which the first liquid level electrode 54 detects the moisturizing liquid. When the moisturizing liquid moisturizes the second ejection liquid, the supply mechanism 42 supplies the replenishment liquid to the reservoir section 22 so as to maintain the state in which the second liquid level electrode 55 detects the moisturizing liquid. According to the above configuration, the moisturizing unit 21 can adjust the concentration of the moisturizing liquid by supplying the replenishment liquid in accordance with the first liquid level electrode 54 or supplying the replenishment liquid in accordance with the second liquid level electrode 55.

### Third Embodiment

Next, a third embodiment of the moisturizing unit 21 will be described. In the third embodiment, the reservoir section 22 is filled with the moisturizing liquid having a concentration suitable for moisturizing the first ejection liquid.

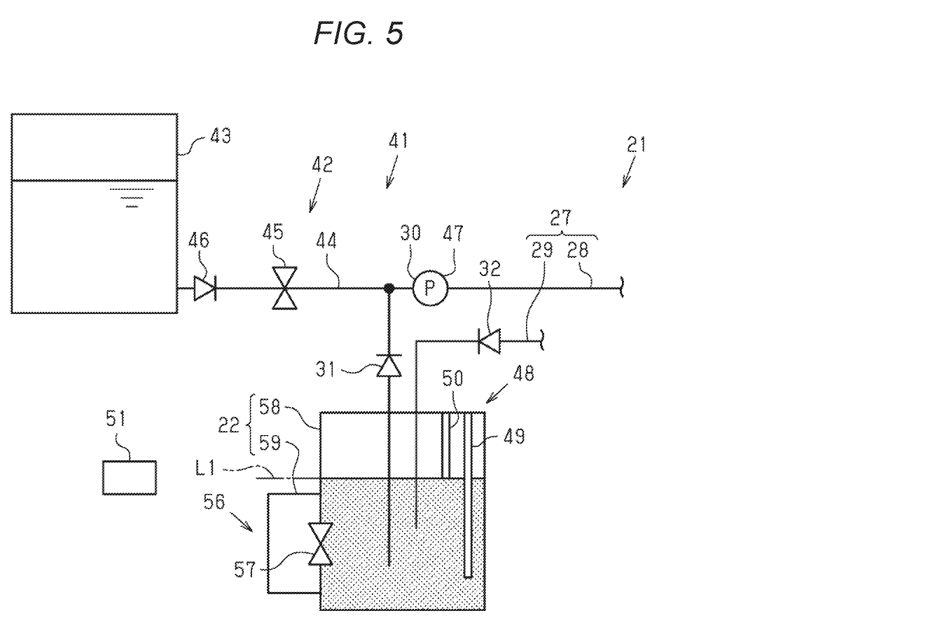

As illustrated in FIG. 5, the adjustment section 41 includes a changing mechanism 56. The changing mechanism 56 is configured to change the volume of the reservoir section 22. The changing mechanism 56 is configured to change the volume of the reservoir section 22 between a first volume and a second volume. The second volume is larger than the first volume.

In the example shown in FIG. 5, the changing mechanism 56 includes an expansion valve 57. The expansion valve 57 is a valve that expands the volume of the reservoir section 22. The expansion valve 57 is attached to the reservoir section 22. When the expansion valve 57 is closed, the reservoir section 22 has the first volume. When the expansion valve 57 is opened, the reservoir section 22 has the second volume. The expansion valve 57 may be a solenoid valve that automatically operates or a valve that is manually operated by the user.

The reservoir section 22 includes a main reservoir 58 and a sub-reservoir 59. The main reservoir 58 is a portion of the reservoir section 22 coupled to the coupling flow path 27. The main reservoir 58 is a portion of the reservoir section 22 to which the liquid level sensor 48 is attached. The volume of the main reservoir 58 is the first volume. The sub-reservoir 59 is attached to the main reservoir 58. The sub-reservoir 59 may be configured detachably from the main reservoir 58. The sub-reservoir 59 is coupled to the main reservoir 58. The sub reservoir 59 is coupled to the main reservoir 58 so as to communicate with the inside of the main reservoir 58 via the expansion valve 57. When the expansion valve 57 is opened, the inside of the sub-reservoir 59 communicates with the inside of the main reservoir 58. The sum of the volume of the main reservoir 58 and the volume of the sub reservoir 59 is the second volume.

In the third embodiment, the reservoir section 22 is filled with the moisturizing liquid in the state of the first volume. That is, the reservoir section 22 is filled with the moisturizing liquid with the expansion valve 57 closed. Therefore, the main reservoir 58 is filled with the moisturizing liquid. At the time, the moisturizing liquid is filled to the reference liquid level L1. Therefore, the reservoir section 22 having the first volume is filled with the moisturizing liquid at the reference liquid level L1.

At the time of using the moisturizing liquid, the liquid amount when the moisturizing liquid is maintained at the reference liquid level L1 is different between the case where the reservoir section 22 has the first volume and the case where the reservoir section 22 has the second volume. By maintaining the moisturizing liquid at the reference liquid level L1 when the reservoir section 22 has the first volume, the moisturizing liquid is maintained in the first liquid amount. By maintaining the moisturizing liquid at the reference liquid level L1 when the reservoir section 22 has the second volume, the moisturizing liquid is maintained in the second liquid amount.

The changing mechanism 56 maintains the reservoir section 22 in the first volume when the moisturizing liquid moisturizes the first ejection liquid. When the moisturizing liquid moisturizes the first ejection liquid, the supply mechanism 42 supplies the replenishment liquid to the reservoir section 22 so as to maintain the moisturizing liquid in the first liquid amount by maintaining the moisturizing liquid at the reference liquid level L1. When the liquid level of the moisturizing liquid falls below the liquid level electrode 50, the supply mechanism 42 supplies the replenishment liquid so that the liquid level of the moisturizing liquid reaches the liquid level electrode 50. Accordingly, the concentration of the moisturizing liquid is maintained in the state at the time of filling.

The changing mechanism 56 changes the reservoir section 22 to the second volume when the moisturizing liquid moisturizes the second ejection liquid. In this case, the changing mechanism 56 opens the expansion valve 57. When the expansion valve 57 is opened, the moisturizing liquid flows from the main reservoir 58 to the sub-reservoir 59. As a result, the moisturizing liquid falls below the reference liquid level L1. When the moisturizing liquid moisturizes the second ejection liquid, the changing mechanism 56 supplies the replenishment liquid to the reservoir section 22 so as to maintain the moisturizing liquid in the second liquid amount by maintaining the moisturizing liquid at the reference liquid level L1. When the liquid level of the moisturizing liquid falls below the liquid level electrode 50, the supply mechanism 42 supplies the replenishment liquid so that the liquid level of the moisturizing liquid reaches the liquid level electrode 50. Accordingly, the concentration of the moisturizing liquid is maintained to be lower than that at the time of filling.

The moisturizing unit 21 adjusts the moisturizing liquid at a concentration corresponding to the volume of the reservoir section 22 by changing the volume of the reservoir section 22. The moisturizing unit 21 can adjust the concentration of the moisturizing liquid by supplying the replenishment liquid to the reservoir section 22 having the first volume so as to maintain the moisturizing liquid at the reference liquid level L1 or supplying the replenishment liquid to the reservoir section 22 having the second volume so as to maintain the moisturizing liquid at the reference liquid level L1.

### Functions and Effects of Third Embodiment

Then, the functions and effects of the third embodiment will be described. According to the third embodiment, the following functions and effects are obtained in addition to (1-1), (1-3), and (1-4).

(3-1) The changing mechanism 56 maintains the reservoir section 22 in the first volume when the moisturizing liquid moisturizes the first ejection liquid. When the moisturizing liquid moisturizes the first ejection liquid, the supply mechanism 42 supplies the replenishment liquid to the reservoir section 22 so as to maintain the moisturizing liquid in the first liquid amount by maintaining the moisturizing liquid at the reference liquid level L1. The changing mechanism 56 changes the reservoir section 22 to the second volume when the moisturizing liquid moisturizes the second ejection liquid. When the moisturizing liquid moisturizes the second ejection liquid, the supply mechanism 42 supplies the replenishment liquid to the reservoir section 22 so as to maintain the moisturizing liquid in the second liquid amount by maintaining the moisturizing liquid at the reference liquid level L1. According to the above configuration, by changing the volume of the reservoir section 22, the liquid amount stored when the moisturizing liquid is maintained at the reference liquid level L1 changes. By maintaining the moisturizing liquid at the reference liquid level L1 when the reservoir section 22 has the first volume, the moisturizing liquid is maintained in the first liquid amount. By maintaining the moisturizing liquid at the reference liquid level L1 when the reservoir section 22 has the second volume, the moisturizing liquid is maintained in the second liquid amount. Therefore, the moisturizing liquid is maintained at different concentrations between the case where the replenishment liquid is supplied to the reservoir section 22 having the first volume so as to maintain the moisturizing liquid at the reference liquid level L1 and the case where the replenishment liquid is supplied to the reservoir section 22 having the second volume so as to maintain the moisturizing liquid at the reference liquid level L1. When the reservoir section 22 having the first volume is filled with the moisturizing liquid at the reference liquid level L1, by supplying the replenishment liquid to the reservoir section 22 maintained in the first volume so as to maintain the moisturizing liquid at the reference liquid level L1, the concentration of the moisturizing liquid is maintained in the state at the time of filling. When the reservoir section 22 having the first volume is filled with the moisturizing liquid at the reference liquid level L1, by supplying the replenishment liquid to the reservoir section 22 changed to the second volume so as to maintain the moisturizing liquid at the reference liquid level L1, the concentration of the moisturizing liquid is maintained in the state lower than that at the time of filling. In this manner, the moisturizing unit 21 can adjust the concentration of the moisturizing liquid by changing the volume of the reservoir section 22.

### Fourth Embodiment

Next, a fourth embodiment of the moisturizing unit 21 will be described. In the fourth embodiment, the reservoir section 22 is filled with the moisturizing liquid having a concentration suitable for moisturizing the first ejection liquid.

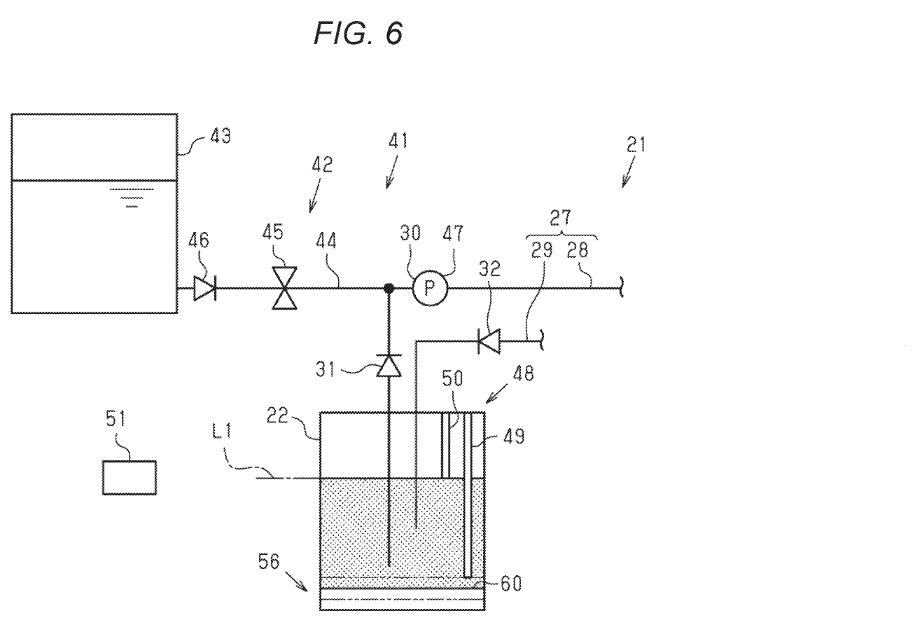

As shown in FIG. 6, similarly to the third embodiment, the adjustment section 41 has the changing mechanism 56. The changing mechanism 56 is configured to change the volume of the reservoir section 22. The changing mechanism 56 is configured to change the volume of the reservoir section 22 between a first volume and a second volume.

In the example illustrated in FIG. 6, the changing mechanism 56 includes a varying body 60. The varying body 60 is located in the reservoir section 22. The varying body 60 is configured to vary the volume. When the volume of the varying body 60 increases, the volume of the reservoir section 22 decreases. When the volume of the varying body 60 decreases, the volume of the reservoir section 22 increases. The varying body 60 may be, for example, a balloon or an elevator. The varying body 60 may be configured to change the space occupied in the reservoir section 22.

The changing mechanism 56 changes the volume of the reservoir section 22 between the first volume and the second volume by varying the volume of the varying body 60. The varying body 60 may be configured to change the volume of the reservoir section 22 among the first volume, the second volume, and a third volume. The third volume is smaller than the first volume.

In the fourth embodiment, the reservoir section 22 is filled with the moisturizing liquid in the state of the first volume. At the time, the moisturizing liquid is filled to the reference liquid level L1. Therefore, the reservoir section 22 having the first volume is filled with the moisturizing liquid at the reference liquid level L1. After filling, when the volume of the varying body 60 decreases, the volume of the reservoir section 22 increases, and thus the liquid level of the moisturizing liquid becomes lower. After filling, when the volume of the varying body 60 increases, the volume of the reservoir section 22 decreases, and thus the liquid level of the moisturizing liquid becomes higher.

At the time of using the moisturizing liquid, the liquid amount when the moisturizing liquid is maintained at the reference liquid level L1 is different between the case where the reservoir section 22 has the first volume and the case where the reservoir section 22 has the second volume. By maintaining the moisturizing liquid at the reference liquid level L1 when the reservoir section 22 has the first volume, the moisturizing liquid is maintained in the first liquid amount. By maintaining the moisturizing liquid at the reference liquid level L1 when the reservoir section 22 has the second volume, the moisturizing liquid is maintained in the second liquid amount.

The changing mechanism 56 maintains the reservoir section 22 in the first volume when the moisturizing liquid moisturizes the first ejection liquid. When the moisturizing liquid moisturizes the first ejection liquid, the supply mechanism 42 supplies the replenishment liquid to the reservoir section 22 so as to maintain the moisturizing liquid in the first liquid amount by maintaining the moisturizing liquid at the reference liquid level L1. When the liquid level of the moisturizing liquid falls below the liquid level electrode 50, the supply mechanism 42 supplies the replenishment liquid so that the liquid level of the moisturizing liquid reaches the liquid level electrode 50. Accordingly, the concentration of the moisturizing liquid is maintained in the state at the time of filling.

The changing mechanism 56 changes the reservoir section 22 to the second volume when the moisturizing liquid moisturizes the second ejection liquid. In this case, the changing mechanism 56 reduces the volume of the varying body 60. When the volume of the varying body 60 decreases, the volume of the reservoir section 22 increases. As a result, the moisturizing liquid falls below the reference liquid level L1. When the moisturizing liquid moisturizes the second ejection liquid, the changing mechanism 56 supplies the replenishment liquid to the reservoir section 22 so as to maintain the moisturizing liquid in the second liquid amount by maintaining the moisturizing liquid at the reference liquid level L1. When the liquid level of the moisturizing liquid falls below the liquid level electrode 50, the supply mechanism 42 supplies the replenishment liquid so that the liquid level of the moisturizing liquid reaches the liquid level electrode 50. Accordingly, the concentration of the moisturizing liquid is maintained to be lower than that at the time of filling.

The moisturizing unit 21 adjusts the moisturizing liquid at a concentration corresponding to the volume of the reservoir section 22 by changing the volume of the reservoir section 22. The moisturizing unit 21 can adjust the concentration of the moisturizing liquid by supplying the replenishment liquid to the reservoir section 22 having the first volume so as to maintain the moisturizing liquid at the reference liquid level L1 or supplying the replenishment liquid to the reservoir section 22 having the second volume so as to maintain the moisturizing liquid at the reference liquid level L1.

In the fourth embodiment, the supply mechanism 42 may fill the reservoir section 22 with the moisturizing liquid having the concentration suitable for moisturizing the second ejection liquid. In this case, the supply mechanism 42 fills the reservoir section 22 having the second volume with the moisturizing liquid. At the time of using the moisturizing liquid, the changing mechanism 56 maintains the reservoir section 22 in the second volume when the moisturizing liquid moisturizes the second ejection liquid. When the moisturizing liquid moisturizes the second ejection liquid, the supply mechanism 42 supplies the replenishment liquid to the reservoir section 22 so as to maintain the moisturizing liquid in the second liquid amount by maintaining the moisturizing liquid at the reference liquid level L1. Accordingly, the concentration of the moisturizing liquid is maintained in the state at the time of filling. At the time of using the moisturizing liquid, the changing mechanism 56 changes the reservoir section 22 to the first volume when the moisturizing liquid moisturizes the first ejection liquid. When the moisturizing liquid moisturizes the first ejection liquid, the supply mechanism 42 supplies the replenishment liquid to the reservoir section 22 so as to maintain the moisturizing liquid in the first liquid amount by maintaining the moisturizing liquid at the reference liquid level L1. Accordingly, the concentration of the moisturizing liquid is maintained higher than that at the time of filling.

### Functions and Effects of Fourth Embodiment

Next, the functions and effects of the fourth embodiment will be described. According to the fourth embodiment, the functions and effects of (1-1), (1-3), (1-4), and (3-1) are obtained.

### Fifth Embodiment

Next, a fifth embodiment of the moisturizing unit 21 will be described. In the fifth embodiment, the concentration of the moisturizing liquid is adjusted by a filling sequence and a replenishment sequence. In the fifth embodiment, the reservoir section 22 is filled with the moisturizing liquid having a concentration suitable for moisturizing the first ejection liquid.

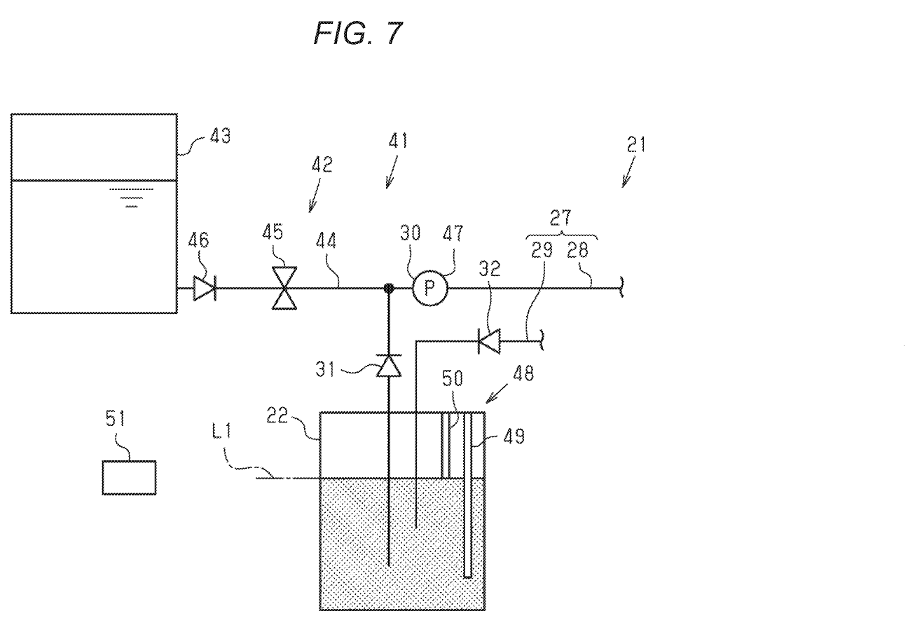

As illustrated in FIG. 7, the reservoir section 22 is filled with the moisturizing liquid at the reference liquid level L1. That is, the supply mechanism 42 fills the reservoir section 22 with the moisturizing liquid such that the liquid level is the reference liquid level L1.

When the moisturizing liquid moisturizes the first ejection liquid, the supply mechanism 42 drives the replenishment pump 47 to maintain the moisturizing liquid in the first liquid amount. When the moisturizing liquid moisturizes the first ejection liquid, the supply mechanism 42 drives the replenishment pump 47 to maintain the moisturizing liquid at the reference liquid level L1. Accordingly, the concentration of the moisturizing liquid is maintained in the state at the time of filling.

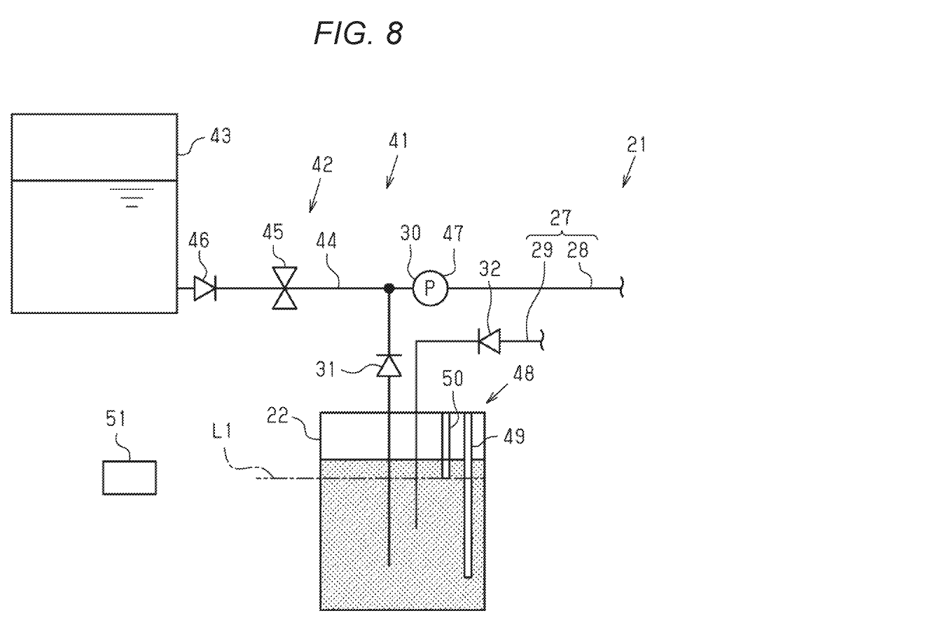

As illustrated in FIG. 8, when the moisturizing liquid moisturizes the second ejection liquid, the supply mechanism 42 supplies the replenishment liquid to the reservoir section 22 so that the moisturizing liquid is in the first liquid amount, and then, drives the replenishment pump 47 by a predetermined amount to supply the replenishment liquid so as to maintain the moisturizing liquid in the second liquid amount. Specifically, when the moisturizing liquid falls below the reference liquid level L1, the supply mechanism 42 drives the replenishment pump 47 to supply the replenishment liquid until the moisturizing liquid reaches the reference liquid level L1. When the moisturizing liquid reaches the reference liquid level L1, the supply mechanism 42 further drives the replenishment pump 47 by a predetermined amount to supply the replenishment liquid in an amount corresponding to the driving amount of the replenishment pump 47. As a result, the liquid level of the moisturizing liquid is maintained to be higher than the reference liquid level L1. That is, the moisturizing liquid is maintained in the second liquid amount. Accordingly, the concentration of the moisturizing liquid is maintained to be lower than that at the time of filling.

### Functions and Effects of Fifth Embodiment

Then, the functions and effects of the fifth embodiment will be described. According to the fifth embodiment, the following functions and effects are obtained in addition to (1-1), (1-3), and (1-4).

(5-1) When the moisturizing liquid moisturizes the first ejection liquid, the supply mechanism 42 drives the replenishment pump 47 to maintain the moisturizing liquid in the first liquid amount. When the moisturizing liquid moisturizes the second ejection liquid, the supply mechanism 42 supplies the replenishment liquid to the reservoir section 22 so that the moisturizing liquid is in the first liquid amount, and then, drives the replenishment pump 47 by a predetermined amount to supply the replenishment liquid so as to maintain the moisturizing liquid in the second liquid amount. According to the above configuration, when the moisturizing liquid moisturizes the first ejection liquid, the concentration of the moisturizing liquid is maintained in the state at the time of filling. When the moisturizing liquid moisturizes the second ejection liquid, the concentration of the moisturizing liquid is maintained to be lower than that at the time of filling. Accordingly, the moisturizing unit 21 can adjust the moisturizing liquid to the concentration suitable for moisturizing the first ejection liquid and the concentration suitable for moisturizing the second ejection liquid.

### Sixth Embodiment

Next, a sixth embodiment of the moisturizing unit 21 will be described. In the sixth embodiment, similarly to the fifth embodiment, the concentration of the moisturizing liquid is adjusted by the filling sequence and the replenishment sequence. In the sixth embodiment, the reservoir section 22 is filled with the moisturizing liquid having a concentration suitable for moisturizing the second ejection liquid.

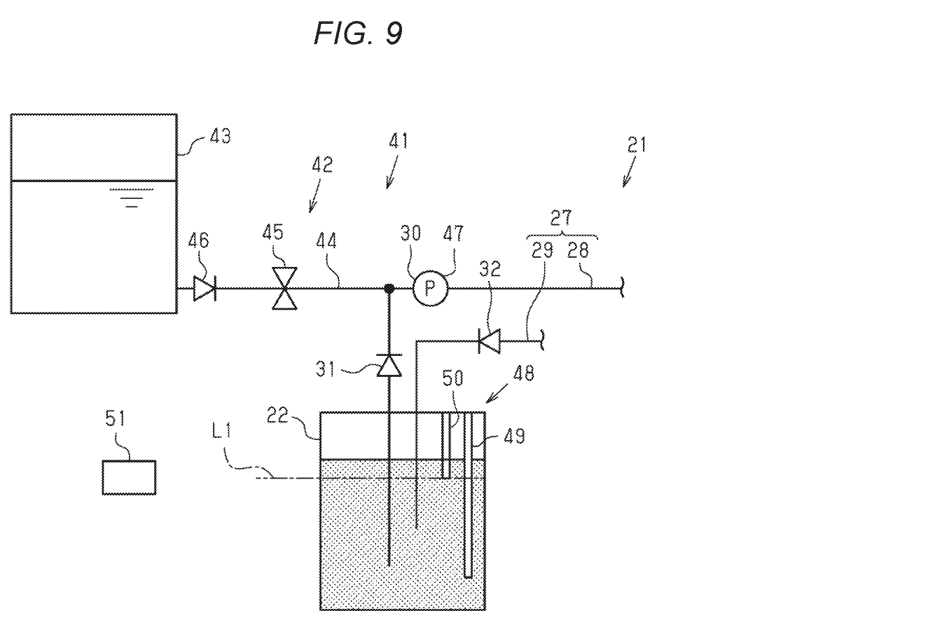

As illustrated in FIG. 9, the reservoir section 22 is filled with the moisturizing liquid at a liquid level higher than the reference liquid level L1. That is, the supply mechanism 42 fills the reservoir section 22 with the moisturizing liquid such that the liquid level is higher than the reference liquid level L1. Specifically, the supply mechanism 42 fills the reservoir section 22 with the moisturizing liquid such that the moisturizing liquid is in the first liquid amount, and then, drives the replenishment pump 47 by a predetermined amount to fill the reservoir section with the moisturizing liquid at a liquid level higher than the reference liquid level L1. At this time, the supply mechanism 42 fills the reservoir section 22 with the moisturizing liquid such that the moisturizing liquid is in the first liquid amount, and then, drives the replenishment pump 47 by a predetermined amount to fill the reservoir section with the moisturizing liquid in the second liquid amount.

When the moisturizing liquid moisturizes the second ejection liquid, the supply mechanism 42 supplies the replenishment liquid to the reservoir section 22 so that the moisturizing liquid is in the first liquid amount, and then, drives the replenishment pump 47 by a predetermined amount to supply the replenishment liquid so as to maintain the moisturizing liquid in the second liquid amount. Specifically, when the moisturizing liquid falls below the reference liquid level L1, the supply mechanism 42 drives the replenishment pump 47 to supply the replenishment liquid until the moisturizing liquid reaches the reference liquid level L1. When the moisturizing liquid reaches the reference liquid level L1, the supply mechanism 42 further drives the replenishment pump 47 by a predetermined amount to supply the replenishment liquid in an amount corresponding to the driving amount of the replenishment pump 47. The predetermined amount is preferably close to the predetermined amount at the time of filling. More preferably, the amounts coincide with each other. The replenishment pump 47 further supplies the replenishment liquid to the moisturizing liquid at the reference liquid level L1, thereby maintaining the liquid level of the moisturizing liquid to be higher than the reference liquid level L1. That is, the moisturizing liquid is maintained in the second liquid amount. Accordingly, the concentration of the moisturizing liquid is maintained in the state at the time of filling.

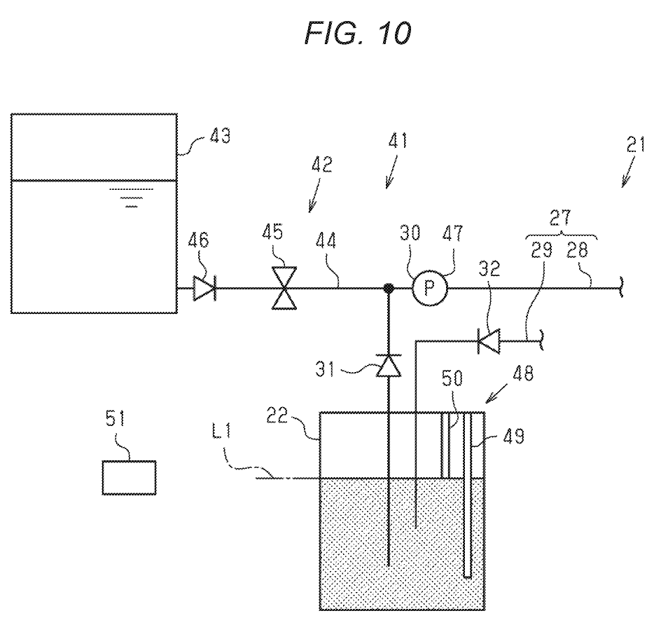

As illustrated in FIG. 10, when the moisturizing liquid moisturizes the first ejection liquid, the supply mechanism 42 drives the replenishment pump 47 to maintain the moisturizing liquid in the first liquid amount. When the moisturizing liquid moisturizes the first ejection liquid, the supply mechanism 42 supplies the replenishment liquid to the reservoir section 22 such that the liquid level is the reference liquid level L1. That is, the supply mechanism 42 supplies the replenishment liquid so as to maintain the state in which the liquid amount of the moisturizing liquid is smaller than that at the time of filling. Accordingly, the concentration of the moisturizing liquid is maintained higher than that at the time of filling.

### Functions and Effects of Sixth Embodiment

Then, the functions and effects of the sixth embodiment will be described. According to the sixth embodiment, the following functions and effects are obtained in addition to (1-1), (1-3), and (1-4).

(6-1) When the moisturizing liquid moisturizes the first ejection liquid, the supply mechanism 42 drives the replenishment pump 47 to maintain the moisturizing liquid in the first liquid amount. When the moisturizing liquid moisturizes the second ejection liquid, the supply mechanism 42 supplies the replenishment liquid to the reservoir section 22 so that the moisturizing liquid is in the first liquid amount, and then, drives the replenishment pump 47 by a predetermined amount to supply the replenishment liquid so as to maintain the moisturizing liquid in the second liquid amount. According to the above configuration, when the moisturizing liquid moisturizes the second ejection liquid, the concentration of the moisturizing liquid is maintained to be close to that at the time of filling. When the moisturizing liquid moisturizes the first ejection liquid, the concentration of the moisturizing liquid is maintained to be higher than that at the time of filling. Accordingly, the adjustment section 41 can adjust the moisturizing liquid at the concentration suitable for moisturizing the first ejection liquid and the concentration suitable for moisturizing the second ejection liquid.

### Technical Ideas

Hereinafter, the technical ideas grasped from the embodiments described above and the functions and effects thereof will be described.

(A) A moisturizing unit is a moisturizing unit that moisturizes a first ejection liquid or a second ejection liquid supplied to an ejection unit, including a reservoir section that stores a moisturizing liquid, and an adjustment section that adjusts a concentration of the moisturizing liquid stored in the reservoir section, wherein the adjustment section includes a liquid level sensor that detects that a liquid level of the moisturizing liquid stored in the reservoir section is a reference liquid level, and a supply mechanism that supplies a replenishment liquid for replenishing moisture to the moisturizing liquid to the reservoir section, and the supply mechanism supplies the replenishment liquid to the reservoir section to maintain the moisturizing liquid in a first liquid amount by maintaining the moisturizing liquid at the reference liquid level when the moisturizing liquid moisturizes the first ejection liquid, and supplies the replenishment liquid to the reservoir section to maintain the moisturizing liquid in a second liquid amount larger than the first liquid amount when the moisturizing liquid moisturizes the second ejection liquid. According to the above configuration, by maintaining the moisturizing liquid in the first liquid amount, the concentration of the moisturizing liquid is maintained constant. Accordingly, the moisturizing liquid moisturizes the first ejection liquid. By maintaining the moisturizing liquid in the second liquid amount, the concentration of the moisturizing liquid is maintained to be lower than that when the moisturizing liquid moisturizes the first ejection liquid. Accordingly, the moisturizing liquid moisturizes the second ejection liquid. As described above, the supply mechanism adjusts the concentration of the moisturizing liquid by supplying the replenishment liquid to maintain the moisturizing liquid in the first liquid amount or the second liquid amount. Therefore, the moisturizing unit can moisturize the first ejection liquid and the second ejection liquid with a single moisturizing liquid.

(B) In the moisturizing unit, the liquid level sensor may include a liquid level electrode that detects the moisturizing liquid by coming into contact with the moisturizing liquid stored in the storage unit, the adjustment section may include a lifting mechanism that lifts and lowers the liquid level electrode, the liquid level electrode may be displaced between a first position and a second position by being lifted and lowered, the first position may be a position where the liquid level electrode detects that the moisturizing liquid is in the first liquid amount, the second position may be a position where the liquid level electrode detects that the moisturizing liquid is in the second liquid amount, and the supply mechanism may supply the replenishment liquid to the reservoir section to maintain a state in which the liquid level electrode located at the first position detects the moisturizing liquid when the moisturizing liquid moisturizes the first ejection liquid, and supply the replenishment liquid to the reservoir section to maintain a state in which the liquid level electrode located at the second position detects the moisturizing liquid when the moisturizing liquid moisturizes the second ejection liquid. According to the above configuration, the moisturizing unit can adjust the concentration of the moisturizing liquid by supplying the replenishment liquid in accordance with the liquid level electrode located at the first position or supplying the replenishment liquid in accordance with the liquid level electrode located at the second position.

(C) In the moisturizing unit, the liquid level sensor may include a first liquid level electrode that detects that the moisturizing liquid is in the first liquid amount, and a second liquid level electrode that detects that the moisturizing liquid is in the second liquid amount, and the supply mechanism may supply the replenishment liquid to the reservoir section to maintain a state in which the first liquid level electrode detects the moisturizing liquid when the moisturizing liquid moisturizes the first ejection liquid, and supply the replenishment liquid to the reservoir section to maintain a state in which the second liquid level electrode detects the moisturizing liquid when the moisturizing liquid moisturizes the second ejection liquid. According to the above configuration, the moisturizing unit can adjust the concentration of the moisturizing liquid by supplying the replenishment liquid in accordance with the first liquid level electrode or supplying the replenishment liquid in accordance with the second liquid level electrode.

(D) In the moisturizing unit, the reservoir section having a first volume may be filled with the moisturizing liquid at the reference liquid level, the adjustment section may include a changing mechanism that changes a volume of the reservoir section between the first volume and a second volume larger than the first volume, the changing mechanism may maintain the reservoir section in the first volume when the moisturizing liquid moisturizes the first ejection liquid, and change the reservoir section to the second volume when the moisturizing liquid moisturizes the second ejection liquid, and the supply mechanism may supply the replenishment liquid to the reservoir section to maintain the moisturizing liquid in the first liquid amount by maintaining the moisturizing liquid at the reference liquid level when the moisturizing liquid moisturizes the first ejection liquid, and supply the replenishment liquid to the reservoir section to maintain the moisturizing liquid in the second liquid amount by maintaining the moisturizing liquid at the reference liquid level when the moisturizing liquid moisturizes the second ejection liquid. According to the above configuration, by changing the volume of the reservoir section, the liquid amount stored when the moisturizing liquid is maintained at the reference liquid level is changed. By maintaining the moisturizing liquid at the reference liquid level when the reservoir section has the first volume, the moisturizing liquid is maintained in the first liquid amount. By maintaining the moisturizing liquid at the reference liquid level when the reservoir section has the second volume, the moisturizing liquid is maintained in the second liquid amount. Therefore, the moisturizing liquid is maintained at different concentrations between a case where the replenishment liquid is supplied to the reservoir section having the first volume to maintain the moisturizing liquid at the reference liquid level and a case where the replenishment liquid is supplied to the reservoir section having the second volume to maintain the moisturizing liquid at the reference liquid level. When the reservoir section having the first volume is filled with the moisturizing liquid at the reference liquid level, by supplying the replenishment liquid to the reservoir section maintained at the first volume to maintain the moisturizing liquid at the reference liquid level, the concentration of the moisturizing liquid is maintained in the state at the time of filling. When the reservoir section having the first volume is filled with the moisturizing liquid at the reference liquid level, by supplying the replenishment liquid to the reservoir section changed to the second volume to maintain the moisturizing liquid at the reference liquid level, the concentration of the moisturizing liquid is maintained to be lower than that at the time of filling. As described above, the moisturizing unit can adjust the concentration of the moisturizing liquid by changing the volume of the reservoir section.

(E) In the moisturizing unit, the reservoir section may be filled with the moisturizing liquid at the reference liquid level, the supply mechanism may include a replenishment pump that supplies the replenishment liquid to the reservoir section, and the supply mechanism may drive the replenishment pump to maintain the moisturizing liquid in the first liquid amount when the moisturizing liquid moisturizes the first ejection liquid, and supply the replenishment liquid to the reservoir section to set the moisturizing liquid in the first liquid amount, and then, drive the replenishment pump by a predetermined amount to supply the replenishment liquid to maintain the moisturizing liquid in the second liquid amount when the moisturizing liquid moisturizes the second ejection liquid. According to the above configuration, when the moisturizing liquid moisturizes the first ejection liquid, the concentration of the moisturizing liquid is maintained in the state at the time of filling. When the moisturizing liquid moisturizes the second ejection liquid, the concentration of the moisturizing liquid is maintained to be lower than that at the time of filling. Accordingly, the moisturizing unit can adjust the moisturizing liquid at a concentration suitable for moisturizing the first ejection liquid and a concentration suitable for moisturizing the second ejection liquid.

(F) In the moisturizing unit, the reservoir section may be filled with the moisturizing liquid at a liquid level higher than the reference liquid level, the supply mechanism may include a replenishment pump that supplies the replenishment liquid to the reservoir section, and the supply mechanism may drive the replenishment pump to maintain the moisturizing liquid in the first liquid amount when the moisturizing liquid moisturizes the first ejection liquid, and supply the replenishment liquid to the reservoir section to set the moisturizing liquid in the first liquid amount, and then, drive the replenishment pump by a predetermined amount to supply the replenishment liquid to maintain the moisturizing liquid in the second liquid amount when the moisturizing liquid moisturizes the second ejection liquid. According to the above configuration, when the moisturizing liquid moisturizes the second ejection liquid, the concentration of the moisturizing liquid is maintained to be close to that at the time of filling. When the moisturizing liquid moisturizes the first ejection liquid, the concentration of the moisturizing liquid is maintained to be higher than that at the time of filling. Accordingly, the moisturizing unit can adjust the moisturizing liquid at a concentration suitable for moisturizing the first ejection liquid and a concentration suitable for moisturizing the second ejection liquid.

(G) The moisturizing unit may include a cap that comes into contact with the ejection unit, and a coupling flow path that is coupled to the cap and the reservoir section. According to the above configuration, moisture is supplied from the moisturizing liquid to the cap through the coupling flow path, and thus the liquid in the ejection unit can be moisturized.

(H) In the moisturizing unit, the coupling flow path may include a supply portion through which the moisturizing liquid flows from the reservoir section toward the cap, and a collection portion through which the moisturizing liquid flows from the cap toward the reservoir section. According to the above configuration, the moisturizing liquid can be circulated between the reservoir section and the cap. Accordingly, the concentration of the moisturizing liquid is easily maintained to be uniform.

(I) A liquid ejection apparatus includes the moisturizing unit and the ejection unit. According to the configuration described above, substantially the same effects as those of the moisturizing unit described above can be obtained.

What is claimed is:

1. A moisturizing unit that moisturizes a first ejection liquid or a second ejection liquid supplied to an ejection unit, the moisturizing unit comprising:
a reservoir section that stores a moisturizing liquid; and
an adjustment section that adjusts a concentration of the moisturizing liquid stored in the reservoir section, wherein
the adjustment section includes
a liquid level sensor that detects that a liquid level of the moisturizing liquid stored in the reservoir section is a reference liquid level, and
a supply mechanism that supplies a replenishment liquid for replenishing moisture to the moisturizing liquid to the reservoir section, and
the supply mechanism supplies the replenishment liquid to the reservoir section to maintain the moisturizing liquid in a first liquid amount by maintaining the moisturizing liquid at the reference liquid level when the moisturizing liquid moisturizes the first ejection liquid, and supplies the replenishment liquid to the reservoir section to maintain the moisturizing liquid in a second liquid amount larger than the first liquid amount when the moisturizing liquid moisturizes the second ejection liquid.

2. The moisturizing unit according to claim 1, wherein
the liquid level sensor includes a liquid level electrode that detects the moisturizing liquid by coming into contact with the moisturizing liquid stored in the storage unit,
the adjustment section includes a lifting mechanism that lifts and lowers the liquid level electrode,
the liquid level electrode is displaced between a first position and a second position by being lifted and lowered,
the first position is a position where the liquid level electrode detects that the moisturizing liquid is in the first liquid amount,
the second position is a position where the liquid level electrode detects that the moisturizing liquid is in the second liquid amount, and
the supply mechanism supplies the replenishment liquid to the reservoir section to maintain a state in which the liquid level electrode located at the first position detects the moisturizing liquid when the moisturizing liquid moisturizes the first ejection liquid, and supplies the replenishment liquid to the reservoir section to maintain a state in which the liquid level electrode located at the second position detects the moisturizing liquid when the moisturizing liquid moisturizes the second ejection liquid.

3. The moisturizing unit according to claim 1, wherein
the liquid level sensor includes:
a first liquid level electrode that detects that the moisturizing liquid is in the first liquid amount; and
a second liquid level electrode that detects that the moisturizing liquid is in the second liquid amount, and
the supply mechanism supplies the replenishment liquid to the reservoir section to maintain a state in which the first liquid level electrode detects the moisturizing liquid when the moisturizing liquid moisturizes the first ejection liquid, and supplies the replenishment liquid to the reservoir section to maintain a state in which the second liquid level electrode detects the moisturizing liquid when the moisturizing liquid moisturizes the second ejection liquid.

4. The moisturizing unit according to claim 1, wherein
the reservoir section having a first volume is filled with the moisturizing liquid at the reference liquid level,
the adjustment section includes a changing mechanism that changes a volume of the reservoir section between the first volume and a second volume larger than the first volume,
the changing mechanism maintains the reservoir section in the first volume when the moisturizing liquid moisturizes the first ejection liquid, and changes the reservoir section to the second volume when the moisturizing liquid moisturizes the second ejection liquid, and
the supply mechanism supplies the replenishment liquid to the reservoir section to maintain the moisturizing liquid in the first liquid amount by maintaining the moisturizing liquid at the reference liquid level when the moisturizing liquid moisturizes the first ejection liquid, and supplies the replenishment liquid to the reservoir section to maintain the moisturizing liquid in the second liquid amount by maintaining the moisturizing liquid at the reference liquid level when the moisturizing liquid moisturizes the second ejection liquid.

5. The moisturizing unit according to claim 1, wherein
the reservoir section is filled with the moisturizing liquid at the reference liquid level,
the supply mechanism includes a replenishment pump that supplies the replenishment liquid to the reservoir section, and
the supply mechanism drives the replenishment pump to maintain the moisturizing liquid in the first liquid amount when the moisturizing liquid moisturizes the first ejection liquid, and supplies the replenishment liquid to the reservoir section to set the moisturizing liquid in the first liquid amount, and then, drives the replenishment pump by a predetermined amount to supply the replenishment liquid to maintain the moisturizing liquid in the second liquid amount when the moisturizing liquid moisturizes the second ejection liquid.

6. The moisturizing unit according to claim 1, wherein
the reservoir section is filled with the moisturizing liquid at a liquid level higher than the reference liquid level,
the supply mechanism includes a replenishment pump that supplies the replenishment liquid to the reservoir section, and
the supply mechanism drives the replenishment pump to maintain the moisturizing liquid in the first liquid amount when the moisturizing liquid moisturizes the first ejection liquid, and supplies the replenishment liquid to the reservoir section to set the moisturizing liquid in the first liquid amount, and then, drives the replenishment pump by a predetermined amount to supply the replenishment liquid to maintain the moisturizing liquid in the second liquid amount when the moisturizing liquid moisturizes the second ejection liquid.

7. The moisturizing unit according to claim 1, further comprising:
a cap that comes into contact with the ejection unit; and
a coupling flow path that is coupled to the cap and the reservoir section.

8. The moisturizing unit according to claim 7, wherein
the coupling flow path includes:
a supply portion through which the moisturizing liquid flows from the reservoir section toward the cap; and
a collection portion through which the moisturizing liquid flows from the cap toward the reservoir section.

9. A liquid ejection apparatus comprising:
the moisturizing unit according to claim 1; and
the ejection unit.
